(19) United States
(12) Patent Application Publication
(10) Pub. No.: US 2004/0137031 A1
(43) Pub. Date: Jul. 15, 2004

(54) Microcapsules with amine adjusted release rates

(75) Inventors: Michael E. Seitz, St. Louis, MO (US); Ronald J. Brinker, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Monsanto Technology LLC

(21) Appl. No.: 10/728,654

(22) Filed: Dec. 5, 2003

Related U.S. Application Data
(60) Provisional application No. 60/433,409, filed on Dec. 13, 2002.

(51) Int. Cl. A01N 25/34

(52) U.S. Cl. 424/408

(57) ABSTRACT

The present invention is directed to controlling the release of microencapsulated materials. The microcapsules have a polymer shell, the precursors of which are selected to adjust the rate at which core materials are released. The present invention is further directed to the formulation of said microcapsules in aqueous dispersions, and to the manufacture of said microcapsules.

### REFERENCE TO RELATED APPLICATION

This application claims priority from U.S. provisional application Serial No. 60/433,409, filed Dec. 13, 2002, the entire contents of which is incorporated herein by reference.

### BACKGROUND OF THE INVENTION

This invention relates to controlling the release of encapsulated materials, and more particularly to microcapsules having polymer shells, the precursors of which are selected to adjust the rate at which core materials are released. This invention also relates to the formulation of said microcapsules in aqueous dispersions and to the manufacture of said microcapsules.

Controlled release for biologically active materials has been a topic of intense interest for the agricultural industry. Controlled release delivery systems offer the promise of reductions in pesticide usage and in volatility losses. Pesticide leaching into ground water, a serious problem for all-at-once methods of delivery typical of emulsifiable and dispersion concentrates, could be significantly reduced by controlled release. Product toxicity effects can be reduced, and better crop safety achieved. These advantages have led to the development of a variety of formulations involving microcapsules and microspheres.

Microencapsulation techniques have been developed, and wide varieties are used extensively in, the graphic arts and pharmaceutical industries. In the agricultural field, however, most commercial techniques are limited to polyurea shells (or alternatively, “shellwalls”) formed by interfacial polymerization. Aromatic isocyanates are used exclusively with either an amine crosslinker as taught in Beestman, U.S. Pat. No. 4,280,833, or another aromatic isocyanate that is hydrolyzed “in-situ” to produce the amine as taught in Scher, U.S. Pat. No. 4,643,764. The process is simple and moderately successful. However the rigid, microporous capsules obtained by such processes have not fully realized the promise of controlled release.

Core material may escape from the microcapsule through a variety of mechanisms. The material may be instantaneously released in the case of a shellwall rupture. Alternatively, core material may “diffuse” or flow through micropores and fissures in the shellwall. Microcapsules formed via the in situ polymerization process often develop such micropores or fissures during production due to the generation of carbon dioxide gas pressure from the hydrolysis of isocyanates or post-production due to environmental stresses. The carbon dioxide of the in situ processes must be either vented during production or stabilized in solution for storage; however, changes in storage conditions may cause the dissolved carbon dioxide to be released, which may deform or burst the storage container. Finally, core material may molecularly diffuse through a shellwall which is permeable to the core material.

In theory three factors control the release of core material through a shellwall by molecular diffusion: 1) the effective diffusion coefficient of the shellwall (i.e., the inherent resistance it exhibits toward permeants), 2) the solubility of the core in the shellwall, or in this case the degree of swelling, often called the partition coefficient, and 3) the thickness of the shellwall. Wall thickness had been the only practical means of adjusting the release in the prior art, usually accomplished by changes in the amount of wall precursors used relative to the core or by changes in particle size while holding the wall to core ratio constant.

Reducing the wall thickness to increase the release rate has definite limitations. The thin walls produced are sensitive to premature mechanical rupture during handling or in the field, resulting in immediate release. Poor package stability can also arise when the core material is in direct contact with the external vehicle through wall defects. Some core materials may crystallize outside the capsule causing problems in spray applications. The product thus becomes little more than an emulsion stabilized against coalescence. When delivered to the field, the release is so fast that little is gained over traditional emulsion concentrate formulations.

If the wall thickness is increased, the bioefficacy quickly drops to a marginal performance level. There is also a practical limit to the wall thickness in interfacial polymerization. As the polymer precipitates, the reaction becomes diffusion controlled. The reaction rate can drop to such an extent that non-constructive side reactions can predominate. Hydrolysis of the isocyanate by residual moisture in the core is one of the more common side reactions. Since this reaction is not interfacial, there is no assurance that this polymerization contributes to wall formation.

Adjusting the release by changing the particle size suffers from the same problems associated with changing wall thickness. It is to some degree another means of adjusting wall thickness. Additionally, interfacial polymerization techniques are ideally suited for production of capsules in the 2 to 12 microns range. Though decreasing the size of the microcapsule increases the ratio of surface area to volume of core material, the release rate does not vary significantly between these two extremes. It is further muted by the averaging effects of broadening size distributions that inevitably occur as the size is increased.

These prior art microencapsulation procedures are thus adequate for producing very fast release rates or very slow release rates. However, the practitioner of this art has great difficulty optimizing the release rates to obtain maximum bioefficacy for a given active. Various formulation solutions have been attempted to address this limitation. For example, two package or single package blends of microcapsules and dispersions or emulsions of free agricultural actives have been proposed in Scher, U.S. Pat. Nos. 5,223,477 and 5,049,182.

Seitz, U.S. Pat. No. 5,925,595, teaches a method for producing a polyurea shellwall having a permeability that can be readily adjusted to control release. The degree of permeability is regulated by a simple compositional change in the precursors for the wall that modifies the segmental mobility of the polymeric wall. In Seitz, a blend of isocyanates is used to produce the desired change in the shellwall composition. One isocyanate introduces the flexible segment into the wall while the other introduces a rigid one. The effective diffusion coefficient for the shellwall can thereby be controlled, which in turn provides a means of controlling the permeability of the shell wall.

### SUMMARY OF THE INVENTION

Among the several features of the present invention, therefore, may be noted, for example, the provision of a controlled-release pesticide vehicle and of a method for improved control of plant growth using the same. Further provided are, for example, a microencapsulated pesticidal compound in a shell from which the compound is released by molecular diffusion; the provision of a process which can be adjusted and controlled to provide a predetermined permeability of the shell; and, the provision of a process which can be adjusted and controlled to adjust the permeability of the shell over a continuum from relatively rapid release to relatively slow release of said compound.

Briefly therefore, the present invention is directed to a pesticidal material comprising a substantially water-immiscible core material encapsulated in a shell. The core material comprises a pesticide. The shell comprises a polymer which is a product of a wall-forming reaction of an isocyanate with other monomers in an encapsulation, shell-forming polymer system. The other monomers comprise a principal amine reactant and an auxiliary amine reactant, said auxiliary amine being reactive with the isocyanate to affect the permeability of the shell with respect to said pesticide.

The invention is further directed to an agricultural formulation comprising a liquid dispersion of microcapsules. The microcapsules comprise polymer shells encapsulating a core material which comprises a pesticidal compound. The core material is encapsulated in a shell comprising a polymer produced by reaction of an isocyanate with other monomers in an encapsulation, shell-forming polymer system, and said other monomers comprise a principal amine reactant and an auxiliary amine reactant. The auxiliary amine is reactive with the isocyanate to affect the permeability of the shell with respect to said pesticide.

The invention is also directed to a process for the preparation of microcapsules and aqueous dispersion of microcapsules comprising the steps of preparing an emulsion comprising an aqueous continuous phase and a discontinuous oil phase and interfacially polymerizing amine reactants in the continuous aqueous phase with isocyanate reactants in the discontinuous oil phase. The oil phase also comprises an emulsifying agent and a core material comprising a pesticide. The core material is encapsulated in a polymer shell produced by the interfacial reaction. The amine reactants comprise a principal amine and an auxiliary amine in a ratio effective to form a shell with a predetermined permeability with respect to the pesticide.

The invention is yet further directed to a method for preparing microcapsules having shells which have a predetermined permeability with respect to an active ingredient encapsulated within. The method comprises the following steps: (i) selecting a first reaction set comprising a first monomer, other monomers, and a core material composition; (ii) reacting the first monomer with the other monomers in an encapsulation, shell-forming polymer reaction system which comprises the core material to form a dispersion of microcapsules, wherein the other monomers react in a known ratio to form the microcapsule shells; (iii) measuring a characteristic half-life of the dispersion of microcapsules, the half-life being calculated from a rate of release of the active ingredient from the microcapsules into water over time; (iv) repeating the reaction and measurement steps, for a number of iterations sufficient to describe the characteristic half-lives of microcapsule dispersions as a function of the ratios of other monomers, wherein each iteration is performed with a unique ratio of other monomers to each other; and (v) performing the reaction step with a ratio of other monomers to each other which correlates to a target characteristic half-life.

The invention is still further directed to a method for selecting a target reaction set for the preparation of microcapsules having a predetermined and bioeffective release rate of an active ingredient. The microcapsules each comprise a polymer shell formed by reacting a first monomer with at least two other monomers, wherein the shell encapsulates a core material which comprises the active ingredient. The process comprises the steps of forming a nomograph which characterizes the relationship between the release rate of the microcapsule and the combinations of other monomer ratios and first monomers, and core material compositions and selecting a target reaction set from a selection line segment on the nomograph.

### BRIEF DESCRIPTION OF THE DRAWINGS

FIG. 1A is a plot which illustrates the release of acetochlor over time from the microcapsules of Examples 1A, B, and C.

FIG. 1B is illustrates the data from FIG. 1A, presented in a plot of Half-Life versus Amine Ratio for a microcapsule system in which an auxiliary amine increases permeability.

FIG. 2 is a plot of Half-Life versus Amine Ratio for a microcapsule system in which an auxiliary amine decreases permeability.

FIG. 3 is a bioefficacy plot for the microcapsules of Examples 1A, 1B, and 1C and a reference pesticide material.

FIGS. 4A and 4B are the bioefficacy data for the microcapsules of Example 4 at application rates of 0.25 and 0.5 lb/acre active ingredient, respectively.

FIG. 5 is an illustration of a shellwall selection scheme for initial selection of microsphere precursors (fixed wall thickness).

### DESCRIPTION OF PREFERRED EMBODIMENTS

In accordance with the present invention, processes have been discovered for encapsulating core materials wherein microcapsules are produced comprising shellwalls having predetermined permeability with respect to the core materials. In turn, the rate of release of the core materials from the microcapsules due to molecular diffusion may be adjusted by controlling the permeability of the shellwalls. The core material comprises at least one active ingredient (“active”), which is a compound desired to be released at a controlled rate. The release rates of such actives, particularly pesticides, encapsulated within a polyurea shell may be controlled by varying the relative amounts of two or more amine monomers participating in a shellwall-forming polymerization reaction with one or more isocyanate monomers. The isocyanate and amine monomers may comprise “prepolymers.”

The shellwall is formed in a polymerization which occurs at the oil/water interface of an oil-in-water emulsion with the amines present in a continuous aqueous phase and isocyanates and pesticide present in a discontinuous oil phase. Since significant benefits discussed elsewhere herein accrue from the avoidance of in situ polymerization, it is preferred that the amines are not products of isocyanate hydrolysis. The variety of amines which are suitable for such a reaction greatly expands the alternatives for producing controlled release microcapsules beyond those available in the prior art.

In an encapsulation, shell-forming polymer system in which an active is encapsulated by the reaction of at least one isocyanate monomer with at least two amine monomers, it has been discovered that the release rate of pesticide from the shells thereby formed varies with the ratio of the amines according to a function which can be determined experimentally. Therefore, the function can be used to predict the permeability to be achieved with a particular amine ratio, and thus to obtain a desired permeability by selection of the ratio. Thus, for a given pesticide and isocyanate combination, the permeability and release rate may be reliably adjusted by adjusting the amine ratio.

The amine ratio is preferably expressed on the basis of amine equivalents (i.e., on a weight basis adjusted for each amine by a factor representing the number of functional amino groups per molecule divided by molecular weight). As an example, the amine ratio (“A/P”) of a mixture comprising 5.75 g of a diamine (“A”) having a molecular weight of 136.2 and 3.09 g of a tetramine (“P”) having a molecular weight of 146.2 is:

$$\frac{( 5.75 g ) \times ( 2 amino groups \text{/} molecule ) / ( 136.2 g \text{/} mole )}{( 3.09 g ) \times ( 4 amino groups \text{/} molecule ) / ( 146.2 g \text{/} mole )}$$

which is equal to 1.00 and gives an amine ratio of 50/50 when normalized for 100 total amine equivalents.

For purposes of differentiating the two amines, one amine is designated the principal amine and the other amine is designated the auxiliary amine. Under such a naming convention, the effect of varying amine ratio on shell permeability can be conveniently described as the increase or decrease in the release rate of an active from a reference microcapsule as the ratio of auxiliary amine to principal amine is increased. The direction and the magnitude of the effect of the auxiliary amine on the release rate of a pesticide is a function of the identity of the pesticide, of the identity of all polymerization reactants, and of the ratio in which the amines react to form the shellwall.

Adjustable, Controlled-Release Microcapsules

Therefore, one embodiment of the present invention is a microcapsule for which the release rate of an active is readily adjustable by selection of precursors of a polymer shell. The active is released from the microcapsule by molecular diffusion through the shellwall. Therefore, release does not rely on the partial or complete destruction of the shell. This is in contrast to prior art in which release is either by permeation through cracks or micropores in the shellwall or by shellwall rupture. Though such references may refer to diffusion, the mechanism has been shown to be flow, not molecular diffusion.

In a preferred embodiment, the microcapsule shell comprises a polyurea polymer. The shell encapsulates a pesticide-containing core material such that molecular diffusion of the pesticide through the shellwall is preferably the predominant release mechanism. In this regard, the shell is structurally intact (i.e., not mechanically harmed nor chemically eroded so as to allow the pesticide to release by a flow mechanism), and is substantially free of defects, such as micropores and fissures of a size which would allow the core material to release by flow. Micropores and fissures may form if gas is generated during a microcapsule wall-forming reaction. For example, the hydrolysis of an isocyanate generates carbon dioxide. Accordingly, the microcapsules of the present invention are preferably formed in an interfacial polymerization reaction in which conditions are controlled to minimize the in situ hydrolysis of isocyanate reactants. For example, important reaction variables for minimizing isocyanate hydrolysis include, but are not limited to: selection of isocyanate reactants, reaction temperature, reaction in the presence of an excess of amine reactants, and wall thickness. These and other variables are discussed further elsewhere herein.

In accordance with this preferred embodiment, the polyurea polymer is the reaction product of reactants comprising a principal amine and an auxiliary amine with at least one polyisocyanate reactant (i.e., having two or more isocyanate groups per molecule). The principal amine and the auxiliary amine are polyamines (i.e., having two or more amine groups per molecule). Preferably, neither the principal amine nor the auxiliary amine are the products of a hydrolysis reaction involving any of the polyisocyanates with which they react to form the above-referenced polyurea polymer. More preferably, the shellwall is substantially free of a reaction product of an isocyanate with the amine generated by the hydrolysis of said isocyanate. This in situ polymerization of an isocyanate and its derivative amine is disfavored for a variety of reasons described elsewhere herein.

It is additionally preferred that the molecular weight of the amine or amines utilized herein be less than about 1000 g/mole, less than about 750 g/mole, or even less than about 500 g/mole. For example, the molecular weight of the amine(s) may range from about 100 to less than about 750 g/mole, or from about 200 to less than about 600 g/mole, or from about 250 to less than about 500 g/mole. Without being held to a particular theory, it is generally believed that steric hindrance is a limiting factor in the shellwall-forming polymerization reaction, given that bigger molecules may not be able to diffuse through the early-forming, proto-shellwall to reach, and react to completion with, for example the isocyanate monomer in the core during interfacial polymerization.

Principal Amines

Preferred principal amines comprise linear alkyl amines. More preferably, the principal amine is selected from the group consisting of compounds of the following structure:

H₂N—X—NH₂

wherein “X” is selected from the group consisting of —(CH₂)ₐ— and —(C₂H₄)—Y—(C₂H₄)—; “a” is an integer having a value from about 2 to about 6, or about 3 to about 5; “Y” is selected from the group consisting of —S—S—, —(CH₂)_{b}—Z—(CH₂)_{b}—, and —Z—(CH₂)ₐ—Z—; “b” is an integer having a value between 0 and about 4, or about 1 to about 3, “a” is as defined above, and “Z” is selected from the group consisting of —NH—, —O—, and —S—.

Preferred examples of principal amines include diethylenetriamine, triethylenetetramine, iminobispropylamine, bis(hexamethylene)triamine, cystamine, triethylene glycol diamine (e.g. Jeffamine EDR-148 from Huntsman Corp., Houston, Tex.), and the alkyl diamines from ethylene diamine to hexamethylene diamine. More preferred amines are triethylenetetramine and triethylene glycol diamine.

Release Rate

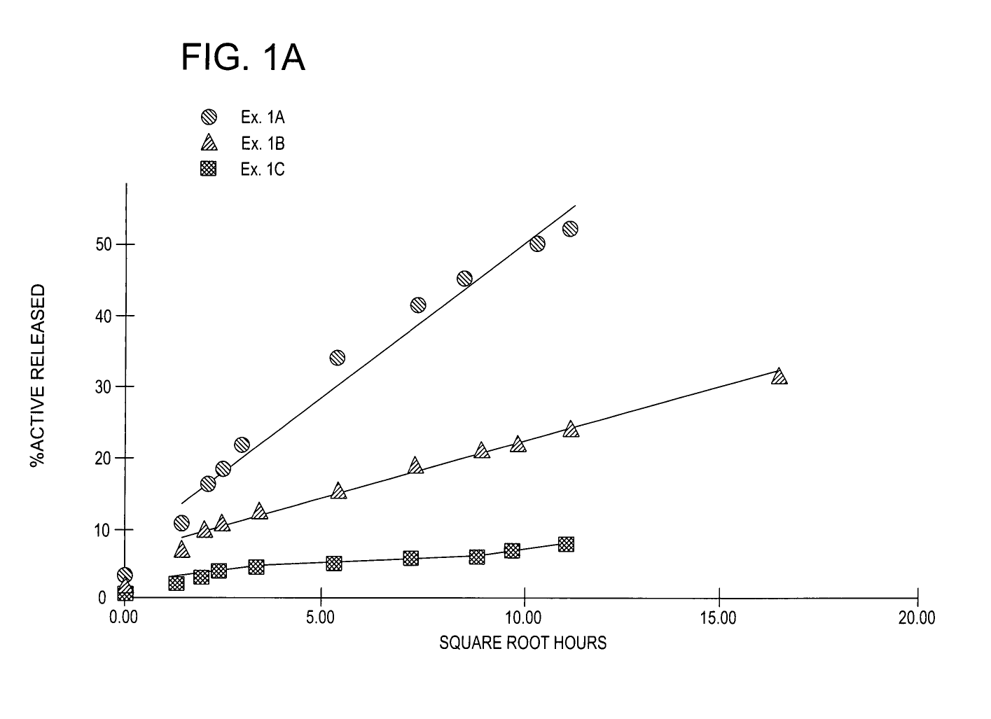

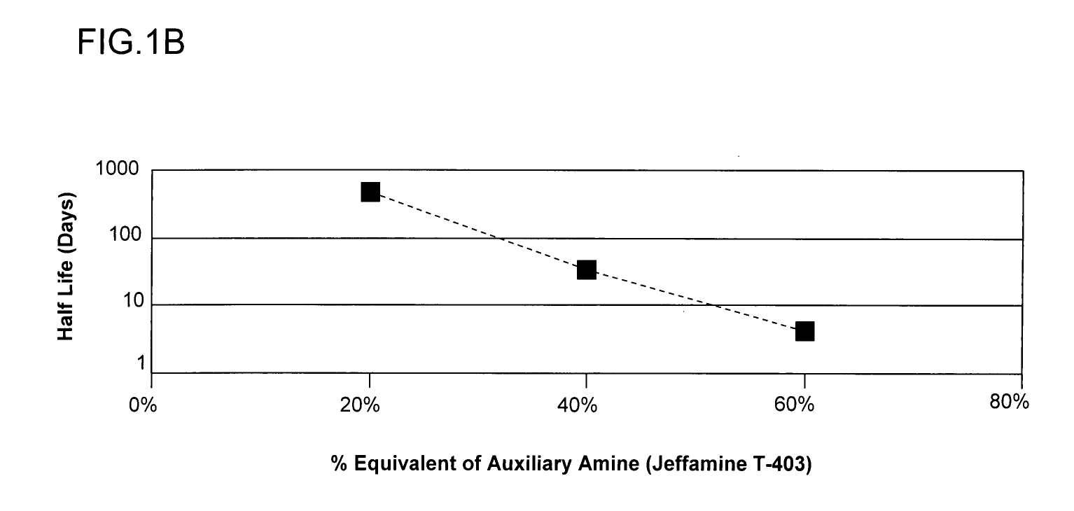

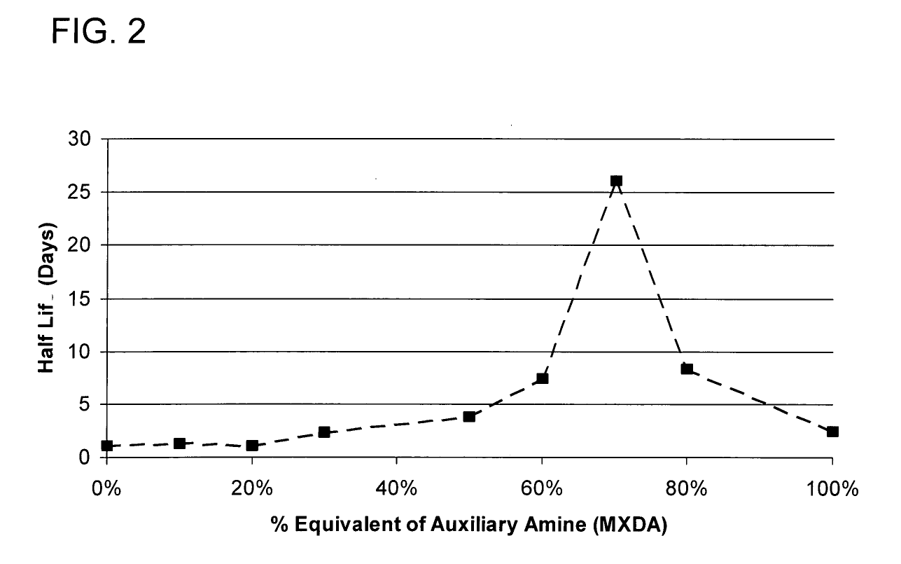

The auxiliary amine is selected as described elsewhere herein, and at least one polyisocyanate is polymerized with the auxiliary and principal amines. The amines are in an amine ratio which is chosen as described elsewhere herein to produce a permeable polyurea shell having a predictable release rate. Briefly, FIGS. 1B and 2 show the relationship between release rate of microcapsules of the present invention and the ratio of an auxiliary amine to a principal amine. Specifically, FIG. 1B plots release rate versus amine ratio for amines selected so that the release rate of a core material generally increases with increasing ratios of auxiliary amine to principal amine. FIG. 2 plots release rate versus amine ratio for amines selected so that the release rate of a core material generally decreases with increasing ratios of auxiliary amine to principal amine.

FIGS. 1B and 2 employ half-life as an indicator of release rate. The half-life of a microcapsule is the time required for one-half the mass of a compound initially present in the core material to release from a microcapsule. Half-life is inversely related to release rate: a smaller half-life value represent a release rate greater than that represented by a larger half-life value. The half-life of an aqueous dispersion of microcapsules, for which the total initial mass of encapsulated pesticide is known, can be experimentally determined. The cumulative mass of pesticide released over time from microcapsules immersed in a relatively large volume of water at a constant temperature is measured and recorded.

This data may be analyzed in various ways of differing complexity. According to one approach, the cumulative mass value is converted into a percent of initial pesticide released and plotted versus the square root of time, and the half-life can be determined from the equation of a line fit to the data at the point which corresponds to a 50% release. According to an alternative approach, the negative of the logarithm of the fraction of the active remaining in the capsule is plotted versus time. The natural log of 0.5 (i.e., ln(0.5)=0.693), is divided by the slope of the line to give the half-life. (See Omni et al., Controlled Release of Water-soluble Drugs from Hollow Spheres: Experiments and Model Analysis,” in Microcapsulation of Drugs, pp. 81-101 (Whately, T. ed., Harwood Academic Publishers 1992).) The plot is linear for microcapsules which conform to an idealized model of molecular diffusion through a spherical shell.

Half-lives of microcapsules of this invention have been calculated according to this method, which is further detailed in Example 1D and FIG. 1A. Preferably, the half-life of microcapsules according to the present invention ranges between about 3 days and 500 days, or about 25 to about 400 days, or about 50 to about 300 days, or about 100 to about 200 days. The release rate in less controlled environments (e.g., in an agricultural field), is not measured by this method; rather, the release of a core material such as a pesticide in the field may be indicated by alternative means (e.g., bioefficacy).

Preferably, the shellwall of microcapsules is substantially non-porous. A substantially non-porous shellwall which is permeable to the encapsulated pesticide can be expected to release by molecular diffusion. Thus, the plot of cumulative release versus the square root of time is preferably substantially linear between about 0% and about 50% of pesticide being released. That is, the release of pesticide behaves according to a theoretical model of molecular diffusion through a hollow microcapsule until at least about 50% of the pesticide contained within the microcapsule is released. More preferably, the plot for microcapsules of the invention is substantially linear to at least about 60%, about 70% or even about 80% of pesticide being released.

When the microcapsules of the present invention have exceeded about 50%, about 60%, about 70% or about 80% release of the core pesticides, the release rate typically becomes lesser than that of the theoretical model. Without adhering to any particular theory, it is believed that the slower release rate is caused by the collapse of the microcapsules. As core materials are released, it is believed that the microcapsules collapse around the remaining core material until voids form between the core material and the shellwall, such that the core material is no longer in contact with a portion of the internal surface of the shellwall. With a smaller area of core material/shell wall interface, the release rate becomes less than that predicted by the theoretical model.

Departure from the theoretical model may also occur in the form of a sudden increase in release rate of core material. As the shellwall collapses, it is possible for the shellwall to rupture, causing such a sudden increase in release rate.

Other indicia of release by molecular diffusion are temperature dependence according to a molecular diffusion model and differential release rates (i.e., different half-lives) for different compounds present in the core. Temperature dependence of release rate is an effective tool for distinguishing the porous microcapsules produced by reactions involving an unacceptably large degree of in situ hydrolysis of the isocyanate reactants from intact microcapsules which release core materials via molecular diffusion. Porous microcapsules demonstrate a release rate characterized by a half-life of about 1 day or less, as determined by the procedure of Example 1D. However, not all microcapsules having a calculated half-life of about 1 day or less are porous. Relatively quick-releasing microcapsules according to the present invention may be distinguished from porous microcapsules by the dependence of the release rate on temperature, specifically the water temperature in the release rate determination procedure described in Example 1D. For example, a porous microcapsule having a release rate characterized by a half-life of about 1 day into water at 30° C. may demonstrate a calculated half-life which is about 2 or 3 days into water at 5° C. The increase in half-life is mostly due to the increase in viscosity of the core material at lower temperatures, causing decreased flow through the pores in the shellwall. For a non-porous shell, release is clearly more temperature dependant. Thus, the increase in measured half-life from release into 30° C. water to release into 5° C. water is much greater (e.g., typically about 5 days greater, about 10 days greater, or more).

A second means of distinguishing porous from substantially non-porous microcapsules is the effect of the addition of core diluents on pesticide release rate. Core diluents are discussed in greater detail elsewhere herein. It is also possible to differentiate between porous and substantially non-porous microcapsules by visual observation with the aid of appropriate microscopy techniques. However, the use of techniques based on release rate dependence on temperature and core diluent compositions are preferred.

Auxiliary Amines

It has been discovered that the selection of, for example, a polyalkyleneamine or an epoxy-amine adduct as the auxiliary amine is useful in providing microcapsules having release rates which increase with an increasing amine ratio (as described elsewhere herein). Preferably, the permeability-increasing auxiliary amine is a polyalkyleneamine which is prepared by reacting an alkylene oxide with a diol or triol to produce a hydroxyl-terminated polyalkylene oxide intermediate, followed by amination of the terminal hydroxyl groups.

More preferably, the auxiliary amine is a polyetheramine (alternatively termed a polyoxyalkyleneamine) according to the following formula:

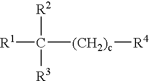

wherein:

c is a number having a value of 0 or 1;

“R¹” is selected from the group consisting of hydrogen and CH₃(CH₂)_{d}—;

“d” is a number having a value from 0 to about 5, or about 1 to about 4;

“R²” and “R³” are

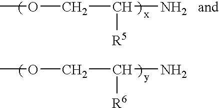

respectively;

“R⁴” is selected from the group consisting of hydrogen and

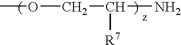

wherein “R⁵”, “R⁶”, and “R⁷” are independently selected from a group consisting of hydrogen, methyl, and ethyl; and,

“x”, “y”, and “z” are numbers whose total ranges from about to 2 to about 40, or about 5 to about 25.

Preferably, the value of x+y+z is no more than about 20. More preferably, the value of x+y+z is no more than about 10.

Examples of useful compounds according to this formula comprise amines of the Jeffamine ED series (Huntsman Corp., Houston, Tex.). A preferred auxiliary amine is Jeffamine T-403 (Huntsman Corp., Houston, Tex.), which is a compound according to this formula wherein c is 0, R¹ is hydrogen, R⁵, R⁶, and R⁷ are each a methyl group and the value of x+y+z is between about 5 and about 6.

The reaction of a polyamine with an epoxy functional compound has been found to produce epoxy-amine adducts which are useful as permeability-increasing auxiliary amines. Epoxy-amine adducts are generally known in the art (being found, for example, in Lee, Henry and Neville, Kris, “Aliphatic Primary Amines and Their Modifications as Epoxy-Resin Curing Agents,” in Handbook of Epoxy Resins, pp. 7-1 to 7-30, McGraw-Hill Book Company (1967)). Preferably, the adduct has a water solubility as described for amines elsewhere herein. Preferably, the polyamine which is reacted with an epoxy to form the adduct is a preferred principal amine as described elsewhere herein. More preferably, the polyamine is diethylenetriamine or ethylenediamine. Preferred epoxies include ethylene oxide, propylene oxide, styrene oxide, and cyclohexane oxide. Diglycidyl ether of bisphenol A (CAS #1675-54-3) is a useful adduct precursor when reacted with an amine in an amine to epoxy group ratio preferably of at least about 3 to 1.

It has further been discovered that the selection of certain ring-containing amines as the auxiliary amine is useful in providing microcapsules with release rates which decrease with increasing amine ratios. Preferably, the permeability-decreasing auxiliary amine is a compound selected from the group consisting cycloaliphatic amines and arylalkyl amines. Aromatic amines (i.e., having the nitrogen of an amine group bonded to a carbon of the aromatic ring), may not be universally suitable. Preferred cycloaliphatic amines include 4,4′-diaminodicyclohexyl methane, 1,4-cyclohexanebis(methylamine), and isophorone diamine. Preferred arylalkyl amines have the structure of the following formula:

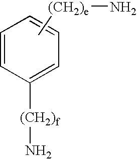

wherein “e” and “f” are integers with a values which independently range from about 1 to about 4, or about 2 to about 3. Meta-xylene diamine, from Mitsubishi Gas Co., Tokyo, JP, is a particularly preferred example of an arylalkyl amine.

It will be recognized that “auxiliary amine” and “principal amine” are relative terms. For example, a principal amine component and a permeability-increasing auxiliary amine component could be arbitrarily renamed as a permeability-decreasing amine and a principal amine, respectively. The effect on permeability that a pair of amines in varying ratios has is more important that the label attached to a given amine structure.

Isocyanates

Isocyanates found useful in this invention comprise, for example, the trifunctional adducts of linear aliphatic isocyanates; namely, the products of the reaction of a diisocyanate containing “n” methylene groups, where n is an integer having a value from about 4 to about 18, or about 8 to about 12, and a coupling reagent such as water or a low molecular triol like trimethylolpropane, trimethylolethane, glycerol, or hexanetriol. Examples of such materials, wherein n is about 6, are a biuret-containing adduct of hexamethylene-1,6-diisocyanate according to the formula below, such as Desmodur N3200 (Miles) or Tolonate HDB (Rhone-Poulenc):

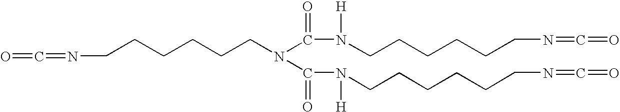

a triisocyanurate of hexamethylene-1,6-diisocyanate such as Desmodur N3300 (Miles) or Tolonate HDT (Rhone-Poulenc), and a triisocyanurate adduct of trimethylolpropane and hexamethylene-1,6-diisocyanate. These comprise isocyanates such as meta-tetramethylxylene diisocyanate, a 4,4′-diisocyanatato-dicyclohexyl methane such as Desmodur W (Miles), and isophorone diisocyanate.

Isocyanates containing an aromatic moiety are also useful in the present invention. These comprise methylene-bis-diphenyldiisocyanate (“MDI”), polymeric MDI (CAS #9016-87-9), toluene diisocyanate, toluene diisocyanate adducts with trimethylolpropane, and MDI terminated polyols.

Isocyanates with an aromatic moiety tend to undergo in situ hydrolysis at a greater rate than aliphatic isocyanates. Since the rate of hydrolysis is decreased at lower temperatures, isocyanate reactants are preferably stored at temperatures no greater than about 50° C., and isocyanate reactants containing an aromatic moiety are preferably stored at temperatures no greater than about 21° C. to about 27° C., and under a dry atmosphere.

Factors Affecting Release Rate

As introduced above, the release mechanism of the present invention is described as molecular diffusion of the core material through the shell. The release rate of the microcapsules of the present invention is controlled by three main factors: (1) the solubility of the core in the shellwall, (2) the resistance of the polymer to movement of core material molecules within due to the chemical composition of the shellwall, and (3) the interaction between these factors.

Core material may be present in the shellwall to facilitate release. Therefore, the amine ratio is an effective tool to adjust release rates only if the shell polymer has some solubility for the core material, or more precisely, if the shellwall is swollen to some finite amount by the core material. The solubility of core material in the shellwall may be predicted by comparing the characteristic solubility parameters of the shellwall with those of the core material.

Calculation of the solubility parameters of the core material and shellwall precursor candidates is a useful method for selecting the isocyanate and principal amine precursors. The Hildebrand solubility parameter, δ, is a well-known expression of the solubility characteristics of a material and may be determined by various methods familiar to those skilled in the art. Example 5 contains the Hildebrand solubility parameters, calculated from the method of Hoftvzer and Van Krevelen, for a variety of polymers and core materials of this invention.

The smaller the absolute value of the difference in solubility parameters of core material and shellwall, the greater the ability of the shellwall to swell with core material. If the difference in solubility parameters is too large, the shell will not be sufficiently permeable to the core material. If the solubility parameters of the shellwall and core material are too similar, the core material plasticizes the shellwall, allowing the core material to release faster than is useful. At the extreme, the core material dissolves the shellwall causing almost instantaneous release. Even the most “rigid” or “crystalline” polymers are susceptible to these mechanisms.

It has been discovered that when the Hildebrand solubility parameter of the core material is within about 5 Joule^{1/2}/cm^{3/2} of that of the shellwall, a microcapsule may release core material via molecular diffusion. Furthermore, nearly immediate release may be expected as the absolute value of the arithmetic difference in the Hildebrand solubility parameters of the core material and shellwall approaches 0, incrementally slower release rates may be expected as the Δδ increases towards 5, and essentially no release for absolute differences greater than about 5.

The calculation of solubility parameters according to the method of Example 5 may contain some inherent error. However, the calculated solubility parameters still provide a useful tool in describing the microcapsules of the present invention. Preferably, the absolute arithmetic difference between the Hildebrand solubility parameters of the shell polymer and the core material is no greater than about 5 Joule^{1/2}/cm^{3/2}. Furthermore, the absolute arithmetic difference between the Hildebrand solubility parameters is preferably no less than about 0.5 Joule^{1/2}/cm^{3/2} and more preferably is no less than about 1 Joule^{1/2}/cm^{3/2}. Accordingly, this difference may preferably range from about 0.5 to about 5 Joule^{1/2}/cm^{3/2}, from about 1 to about 4 Joule^{1/2}/cm^{3/2}, or from about 2 to about 3 Joule^{1/2}/cm^{3/2}.

With an estimate of Δδ for a reference polymer/core material system, the release rate of microcapsules may be increased or decreased by selection of an auxiliary amine which results in a polymer having a greater or lesser value of Δδ than the reference system. The replacement of an auxiliary amine for a principal amine may increase the release rate of the microcapsule relative to a reference system when the resulting polymer shell has solubility parameters which are more similar to the parameters of the core material than the shell would be without the replacement of amines. Conversely, replacement of an auxiliary amine for a principal amine may decrease the release rate of the microcapsule when the resulting polymer shell has solubility parameters which are less similar to the parameters of the core material than the shell would be without the replacement of amines.

Alternatively, the composition of the core material may be changed to have a similar effect. Thus, the core material may optionally comprise a diluent selected to modify the solubility parameter characteristics of the core material. Simply stated, a diluent may be selected to make the core material more soluble or less soluble in the shell than the core material would be without the diluent. Based on this characterization, whether a material is a poor solvent (i.e., decreases the permeability of the core material in the shell) or a good solvent (i.e., increases the permeability of the core material in the shell), depends on whether the addition of a diluent increases or decreases the value of Δδ. Since the value of δ for polymer shells and for pesticides can vary widely, a solvent cannot be classified as a “good solvent” or “poor solvent” on the basis of its solubility parameter alone. Generally, if Δδ for the solvent and the shellwall is less than the Δδ for the active and the shellwall, the solvent will be a good solvent, and the lower its Δδ value is with respect to the shellwall, the better a solvent it will be. Also generally, if Δδ for the solvent and the shellwall is greater than the Δδ for the active and the shellwall, the solvent will be a poor solvent, and the greater Δδ value of the solvent is with respect to the shellwall, the worse that it will be.

For the preferred polyurea/pesticide combinations of the present invention, paraffinic oils having about 12-28 carbon atoms and alkylated biphenyls or naphthalenes are useful as poor solvents. Examples of poor solvents are Norpar 15, Exxsol D 110 and D130, Orchex 692 (all from Exxon Co.); Suresol 330 (from Koch); and, diisopropyl naphthalene. Good solvents for the shell may be added to the core material to increase the release rate of the microcapsule. For the preferred polyurea/pesticide combinations of the present invention, highly aromatic solvents or esters are useful as good solvents. Examples of good solvents are Aromatic 200 (Exxon), Citroflex A-4 (Pfizer), and diethyl adipate. One skilled in the art will recognize that the release rate of the microcapsules may be selected by independently varying the proportion of auxiliary amine or varying the core material composition with diluents or by employing both variations in conjunction with one another.

It is to be noted that while the core is selected to be soluble in the shellwall, this may not ensure a semi-permeable microcapsule. This is because the second factor above (i.e., the resistance of the shell polymer to movement of core material molecules within), may have a greater effect on release rates than the ability of the core material to swell the shellwall. This resistance is determined by the freedom of movement of the polymer segments comprising the shell. Typically, alkyl and alkyl ether linkages provide amorphous and flexible segments that promote movement and thereby faster release. Conversely, aromatic or cyclic hydrocarbon rings tend to produce rigid or crystalline regions that retard movement and slow release. Amine blends may be used to adjust the release rate of the microcapsules of the present invention by modifying the segment mobility of the shell polymer by incorporation of amines having relatively flexible or crystalline natures.

A relative measure of the crystallinity of some polyurea polymer precursors is given in Table 4 in Example 5. It is generally expected that the permeability of a microcapsule will decrease as an amine with a higher degree of crystallinity is substituted for an amine with a lower degree of crystallinity in a polyurea system based on a fixed polyisocyanate composition. The reverse of this substitution is also generally true.

Without adhering to a particular theory, it is believed that the microcapsule release rates of the system in FIG. 2 and Example 2 are driven by the physical structure effects of the auxiliary amine, meta-xylene diamine, on the shell polymer. As the number of aromatic regions in the shell polymer increases with an increasing proportion of the auxiliary amine, it is further believed that the movement of the polymer is retarded and release rate consequently decreases and the half-life increases. At high auxiliary to principal amine ratios, the measured release rate may surprisingly begin to increase as in FIG. 2. The shell thus becomes not only impermeable with respect to molecular diffusion of the core material, but also “brittle” to the extent that fissures form in the shell which allow the core material to flow from the microcapsule, causing relatively quick release.

The sometimes contrary effects of solubility parameters and polymer crystallinity on overall shellwall permeability may be considered in the selection of a readily adjustable release microcapsule system. The degree of the solubility of the core material in the shell polymer can influence the segment mobility of the shell polymer. This interaction, listed as factor 3 above, can change the sensitivity of the rate of release to compositional changes within the shellwall polymer. A large degree of swelling will tend to negate the resistance effect from segment structure reflected in diffusion coefficient changes. When a precise control of solubility is combined with compositional permutations and chemical (i.e., structural) permutations, all achieved through amine blends, the release may be finely controlled.

Physical Parameters of the Microcapsules

The microcapsules of the present invention may be modeled as spheres to express their size with one number. Specifically, their size is preferably measured in terms of the diameter of a sphere which occupies the same volume as the microcapsule being measured. The characteristic diameter of a microcapsule may be directly determined, for example, by inspection of a photomicrograph. Preferably a microcapsule of the present invention has a diameter of less than about 60 microns (e.g., between about 0.1 and about 60 microns). More preferably a microcapsule has a diameter less than about 30 microns (e.g., between about 1 micron and about 30 microns). Even more preferably a microcapsule has a diameter between about 1 micron and about 6 microns.

The size distribution of a sample of microcapsules is preferably measured by a particle analyzer by a laser light scattering technique. Generally, particle size analyzers are programed to analyze particles as though they were perfect spheres and to report a volumetric diameter distribution for a sample on a volumetric basis. An example of a suitable particle analyzer is the Coulter LS-130 Particle Analyzer. This device uses laser light at around a 750 mm wavelength to size particles from about 0.4 microns to about 900 microns in diameters by light diffraction.

The thickness of a microcapsule shell is an important factor. For a reference system having shell precursors which react in a constant ratio to encapsulate a core material having components which are in a constant ratio, an increase in shell thickness leads to a decrease in release rate, and conversely a decrease in shell thickness leads to an increase in release rate. However, adjusting release rates by varying the amine ratio is preferred to varying the shell thickness because there are practical limits as to how thin or thick shells may be made. Shells which are too thin have insufficient integrity to withstand mechanical forces and remain intact. Shells which lack mechanical integrity are prone to defects and destruction, causing the core material to be released by a flow mechanism rather than the desired diffusion mechanism. Shells which are too thick are uneconomical, having more shell material than is required to contain the core material. Furthermore, microcapsules having shells of great thickness take on the disfavored release characteristics of microspheres, in which the core material is dispersed throughout a spherical polymer matrix.

The thickness of a microcapsule shell of the present invention may be expressed as a percentage representing the ratio of the weight of the shell to the weight of the core material. Preferably the weight ratio of shell to core is less than about 50% (e.g., between about 5% and about 50%). More preferably the weight ratio is less than about 33% (e.g., between about 5% and 33%). Still more preferably, the weight ratio is less than about 15% (e.g., between about 5% and 15%).

Alternatively, the average shellwall thickness may be characterized in conventional linear terms, which are calculated from the aforementioned weight ratio according to the following expression:

Equivalent Thickness=[(W+1)^{1/3}−1]*(0.5×D)

wherein W is the aforementioned ratio of the weight of the shell to the weight of the core material and D is a characteristic diameter of the microcapsule. Generally then, for microcapsules having a wall to core weight ratio between about 5% and about 15%, the equivalent thickness of shells is between about 1.5% and about 5% of the diameter of a microcapsule.

Preferably, the equivalent shellwall thickness of a microcapsule having a diameter between about 0.1 and about 60 microns is between about 0.001 and 4 microns, more preferably between about 0.001 microns and about 2 microns, and still more preferably between about 0.001 microns and about 1.4 microns. Likewise, for microcapsule diameters between about 1 micron and 30 microns, the equivalent shellwall thickness is preferably between about 0.01 and 2 microns thick, more preferably between about 0.01 microns and about 1.5 microns, and still more preferably between about 0.01 microns and about 0.7 microns. For microcapsule diameters between about 1 micron and 6 microns, the equivalent shellwall thickness is preferably between about 0.01 and 0.4 microns thick, more preferably between about 0.01 microns and about 0.3 microns, and still more preferably between about 0.01 microns and about 0.14 microns.

Core Material Composition

In a preferred embodiment, the core material comprises a pesticide. The term “pesticide”, as used herein, includes chemicals used as active ingredients of products for control of crop and lawn pests and diseases, animal ectoparasites, and other pests in public health. The term also includes plant growth regulators, pest repellents, synergists, herbicide safeners (which reduce the phytotoxicity of herbicides to crop plants) and preservatives, the delivery of which to the target may expose dermal and especially ocular tissue to the pesticide. More preferably the core material comprises an acetanilide. Still more preferably the core material comprises acetochlor, alachlor, butachlor, or triallate. The core material may comprise multiple compounds for release. A useful combination of compounds is a herbicide and its corresponding safener (e.g., acetochlor and MON 13900, commercially available from Monsanto).

In this regard it is to be noted that the safener MON 13900 is more commonly known as furilazole, which may also be known as (RS)-3-dichloroacetyl-5-(2-furyl)-2,2-dimethyloxazolidine (IUPAC) or (±)-3-dichloroacetyl-5-(furanyl)-2,2-dimethyloxazolidine (Chemical Abstracts).

As described heretofore, the core material may also comprise a diluent. The diluent may be added to change the solubility parameter characteristics of the core material to increase or decrease the release rate of the active from the microcapsules. Preferably, the core material comprises between about 0% and about 10% by weight of a diluent, or about 2% to about 8% by weight. It is preferred to minimize the amount of diluent present in the core material by optimizing the polyurea shell to obtain a desired release rate of an active.

Useful core materials are a single phase liquid at temperatures of less than about 80° C. Preferably, the core material is liquid at temperatures of less than about 65° C. More preferably, the core material is liquid at temperatures of less than about 50° C. The core material may also comprise solids in a liquid phase. Whether liquid or solids in a liquid, the core material preferably has a viscosity such that it flows easily to facilitate transport by pumping and to facilitate the creation of an oil-in-water emulsion as part of a method for preparation of microcapsules discussed herein below. Thus, the core material preferably has a viscosity of less than about 1000 centipoise (e.g., less than about 750 Contopus, or even 500 contopus). Preferably, the core material is substantially water-immiscible, a property which promotes encapsulation by interfacial polymerization.

Liquid Microcapsule Dispersions

A further embodiment of the present invention is a liquid dispersion of microcapsules of the present invention. More specifically, the structure of the microcapsules comprises a substantially water-immiscible, agricultural chemical-containing core material encapsulated by a shell, which is preferably substantially non-porous and which is permeable to the agricultural chemical, which comprises a polyurea product of a polymerization of an isocyanate, a principal amine, and an auxiliary amine. The liquid medium in which the microcapsules are dispersed is preferably water, and the dispersion is preferably further formulated with additives described elsewhere herein.

Preferred Dispersion Parameters and Compositions

It is preferred that the size distribution of the microcapsules in the dispersion fall within certain limits. When the distribution is measured with a laser light scattering particle size analyzer, the diameter data is preferably reported as a volume distribution. Thus the reported median for a population of microcapsules will be volume-weighted, with about one-half of the microcapsules, on a volume basis, having diameters less than the median diameter for the population. Preferably, the reported median diameter of the microcapsules of the aqueous agricultural dispersion is less than about 15 microns with at least about 90%, on a volume basis, of the microcapsules having a diameter less than about 60 microns. More preferably the median diameter of the microcapsules is between about 2 microns and about 8 microns with at least about 90%, on a volume basis, of the microcapsules having a diameter of less than about 30 microns. Even more preferably the median diameter is between about 2 microns and about 5 microns.

The aqueous dispersion of microcapsules is preferably formulated to optimize its shelf stability and safe use. Dispersants and thickeners are useful to inhibit the agglomeration and settling of microcapsules. This function is facilitated by the chemical structure of these additives as well as by equalizing the densities of the aqueous and microcapsule phases. Anti-packing agents are useful when the microcapsules must be redispersed. A pH buffer can be used to maintain the pH of the dispersion in a range which is safe for skin contact and, depending upon the additives selected, in a narrower pH range that may be required for the stability of the dispersion.

Low molecular weight dispersants may solubilize microcapsule shellwalls, particularly in the early stages of their formation, causing gelling problems. Thus, the preferred dispersants have molecular weights of at least about 1.5 kg/mole, more preferably of at least about 3 kg/mole, and still more preferably ranging from about 5 kg/mole to about 50 kg/mole (e.g., about 10 to about 40 kg/mole, or about 20 to about 30 kg/mole). Dispersants may be non-ionic or anionic. An example of a high molecular weight, anionic polymeric dispersant is polymeric naphthalene sulfonate sodium salt, such as Irgasol DA (Ciba Specialty Chemicals). Other useful dispersants are gelatin, casein, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, sodium and calcium lignosulfonates, sulfonated naphthalene-formaldehyde condensates, modified starches, and modified cellulosics like hydroxyethyl or hydroxypropyl cellulose, and sodium carboxy methyl cellulose.

Thickeners are useful in retarding the settling process by increasing the viscosity of the aqueous phase. Thixotropic (i.e., shear-thinning), thickeners are preferred, because they result in a reduction in dispersion viscosity during pumping, which facilitates the economical application and even coverage of the dispersion to an agricultural field using the equipment which is commonly used for such purpose. Preferably, the viscosity of the microcapsule dispersion ranges between about 100 cps to about 400 cps, as tested with a Haake Rotovisco Viscometer and measured at 10° C. by a spindle rotating at 45 rpm. More preferably the viscosity ranges between about 100 cps to about 300 cps. A few examples of useful thixotropic thickeners include water-soluble, guar- or xanthan-based gums (e.g. Kelzan from CPKelco), cellulose ethers (e.g. ETHOCEL from Dow), modified cellulosics and polymers (e.g. Aqualon thickeners from Hercules), and microcrystalline cellulose anti-packing agents.

Adjusting the density of the aqueous phase to approach the average weight per volume of the microcapsules also slows down the settling process. In addition to their primary purpose, many additives may increase the density of the aqueous phase. Further increase can be achieved by the addition of sodium chloride, glycol, urea, or other salts. The mass to volume ratio of microcapsules of preferred dimensions is approximated by the density of the core material where the density of the core material is between about 1.1 and about 1.5 g/cm³. Preferably, the density of the aqueous phase is formulated to within about 0.2 g/cm³ of the weight average mass to volume ratio of the microcapsules. More preferably the density of the aqueous phase ranges from about 0.2 g/cm³ less than the weight average mass to volume ratio of the microcapsules to about equal to the weight average mass to volume ratio of the microcapsules.

Anti-packing agents facilitate redispersion of microcapsules upon agitation of a formulation in which the microcapsules have settled. A microcrystalline cellulose material, such as Lattice from FMC, is effective as an anti-packing agent. Other suitable anti-packing agents are clay, silicon dioxide, insoluble starch particles, and insoluble metal oxides (e.g., aluminum oxide or iron oxide). Anti-packing agents which change the pH of the dispersion are preferably avoided. Preferably, the dispersions of the present invention are easily redispersed and so avoid problems associated with application, (e.g., clogging a spray tank). Dispersability is measured by the Nessler tube test, wherein Nessler tubes are filled with 95 ml of water, then 5 ml of the test formulation is added by syringe. The tube is stoppered, and inverted ten times to mix. It is then placed in a rack, standing vertically, for 18 hours at 20° C. The tubes are removed and smoothly inverted every five seconds until the bottom of the tube is free of material. The number of inversions required to remix the settled material from the formulation is recorded. Preferably, the dispersions of the present invention are redispersed with less than about 100 inversions, as measured by a Nessler tube test. More preferably, less than about 80, about 60, about 40 or even about 20 inversions are required for redispersion.

The pH of the formulated dispersion preferably ranges from about 4 to about 9 to minimize eye irritation of those persons who may come into contact with the formulation in the course of handling or application to crops. If components of a formulated dispersion are sensitive to pH, buffers such as disodium phosphate may be used to hold the pH in a range within which the components are most effective. Example 2 presents a system in which a pH buffer, such as citric acid monohydrate, is particularly useful during the preparation of microcapsules to maximize the effectiveness of a protective colloid such as Sokalan CP9. The role of protective colloids is elsewhere herein.

Other useful additives are biocides, e.g. Proxel from Avecia, preservatives, antifreeze agents, e.g. glycerol, and antifoam agents (e.g., Antifoam SE23 from Wacker Silicones Corp.).

Controlling Plant Growth with Microcapsule Dispersions

These dispersions are useful as controlled-release pesticides or concentrates thereof. Therefore, the present invention is also directed to a method of applying a dispersion of microencapsulated pesticides for controlling plant growth. In a preferred embodiment, the dispersion may be applied to an agricultural field in an effective amount for the control of the varieties of plants and pests for which the pesticide has been selected. “Agricultural field” comprises any area where it is desirable to apply pesticides for the control of weeds, pests, and the like, and includes, but is not limited to, farmland, greenhouses, experimental test plots, and lawns. The dispersions of the present invention are capable of better control of plants and pests over time than an equivalent amount of unencapsulated pesticide. Example 4 compares the bioeffectiveness of triallate pesticide encapsulated in microcapsules having differing release rate characteristics versus unencapsulated triallate.

A microcapsule dispersion may be applied to plants (e.g., crops in a field), according to practices known to those skilled in the art. The microcapsules are preferably applied as an extended release delivery system for an agricultural chemical or blend of agricultural chemicals contained within. Because the average release characteristics of a population of microcapsules of the present invention are adjustable, tight control of the release rate can result in improved bioefficacy of a herbicide. As in Examples 1 and 4, extended release of a herbicidal core material may result in improved bioefficacy when compared to application of an unencapsulated emulsion.

The relationship of the duration of bioefficacy of microcapsule dispersions in the field to the release characteristics of microcapsules as measured by the method described in Example 1D is rarely one-to-one. That is, if bioefficacy is defined as 80% weed control, a dispersion of microcapsules immersed in water may have a calculated half-life of 30 days, yet be bioeffective for 75 days. The exact relationship is not easily predicted, being dependent on complex interactions of multiple variables, but the relationship may be empirically determined by performing standard bioefficacy tests with dispersions of measured half-lives, according methods known in the art. Such methods are employed in Examples 1 and 4.

Accordingly, the preferred half-life of microcapsules to be applied to crops depends upon numerous factors, including the identity of the crop, the identity of the agricultural chemical, and the weather and soil conditions during the growing season. One skilled in the art may take such factors into account and select a herbicidal formulation of the present invention having a useful half-life. For example, a preferred dispersion for application to corn crops under many environmental conditions comprises acetanilide-encapsulated microcapsules with a measured half-life of at least about 5 days, more preferably at least about 30 days and even more preferably at least about 45 days. Microcapsules with half-lives which are too short may not be bioeffective for the required duration (i.e., until the crops are harvested or have established a canopy). Furthermore, microcapsules with a half-life which is too long may not be bioeffective soon enough after application and may wastefully release pesticide long after pesticide is required to protect the crops. Thus, the microcapsules preferably have a half-life no greater than about 100, about 80, or even about 60 days, although microcapsules having a half-life ranging from about 60 to about 100 days are useful when the dispersion is formulated with an unencapsulated herbicide to provide protection in the days immediately following application.

When blended for end use on an agricultural field, the dispersion of pesticide-containing microcapsules prior to dilution by the end user is preferably less than about 62.5 weight percent microcapsules, or alternatively, less than about 55 weight percent pesticide or other active. If the dispersion is too concentrated with respect to microcapsules, the viscosity of the dispersion may be too high to pump and also may be too high to easily redisperse if settling has occurred during storage. It is for these reasons that the dispersion preferably has a viscosity of less than about 400 contopus, as describe above.

The dispersion may be as dilute with respect to microcapsule weight percent as is preferred by the user, constrained mainly by the economics of storing and transporting the additional water for dilution and by possible adjustment of the additive package to maintain a stable dispersion. Typically the dispersion is at least about 40 weight percent active (45 weight percent microcapsules) for these reasons. These concentrations are useful compositions for the storage and transport of the dispersions.

However, if storage and transport economics are not critical the dispersions may have lower concentrations of microcapsules. Preferably, dispersions have a viscosity of at least about 5 contopus prior to dilution by the end user. The viscosity may be measured with a Brookfield viscometer with a spindle size 1 or 2 and at about 20 to about 60 rpm speed. Dispersions which are at least about 5% by weight microcapsules typically exceed this minimum preferred viscosity.

The dispersion may be the only material applied or it may be blended with other agricultural chemicals or additives for concurrent application. Examples of agricultural chemicals which may be blended include fertilizers, herbicide safeners, complimentary pesticides, and even the free form of the encapsulated pesticide. For a stand-alone application, the dispersion is preferably diluted with water prior to application to an agricultural field. Preferably, no additional additives are required to place the dispersion in a useful condition for application as a result of dilution. The optimal concentration of a diluted dispersion is dependent in part on the method and equipment which is used to apply the pesticide. In the case of equipment which performs a spray application, the dispersion is preferably diluted with water to achieve a dispersion viscosity of about 5 contopus. Typically, a concentrated dispersion of about 45 weight percent microcapsules may be diluted to a preferred viscosity by combining the dispersion and water in a volumetric ratio of about 5 parts dispersion to about 95 parts water.

The effective amount of microcapsules to be applied to an agricultural field is dependent upon the identity of the encapsulated pesticide, the release rate of the microcapsules, the crop to be treated, and environmental conditions, especially soil type and moisture. Generally, application rates of pesticides, such as acetochlor, are on the order of about 2 pounds of pesticide per acre. However, the amount may vary by an order of magnitude or more, as demonstrated by the 0.25 and 0.5 pound per acre rates employed in Example 4. Since the encapsulated pesticide of the present invention may achieve greater effectiveness than unencapsulated pesticide at equivalent application rates, an encapsulated pesticide may be expected to achieve the same effectiveness as unencapsulated pesticide at lower rates. Pesticide use may thereby be reduced.

Use of the encapsulated pesticides of the present invention provides additional advantages over unencapsulated pesticides. A common unencapsulated pesticide package is a pesticide emulsified in water. The effectiveness of sprayed pesticide is dependent in part upon the size and distribution of pesticide particles. In a given emulsified pesticide package, particle size distribution is determined in part by the agitation to which the emulsion is subjected prior to application. Emulsion particle size and distribution is hard to control by the average user. Advantageously, the dispersion of the present invention comprises microcapsules having a constant particle size distribution which is set at the time of manufacture. Therefore, no additional care is necessary with regards to controlling particle size and distribution, and the user does not risk wasting pesticide through mishandling the agitation that emulsions require.

Method of Producing Microcapsules and Dispersions

The present invention is further directed to a novel and advantageous process for making the microcapsules and dispersions of microcapsules. An aqueous dispersion of the microcapsules of the invention may be produced in an interfacial polymerization reaction system. In a preferred embodiment, a principle and an auxiliary amine are polymerized with an isocyanate at the interface of an oil-in-water emulsion. Preferably, the discontinuous oil phase comprises the isocyanate and a continuous aqueous phase comprises the amines. As previously noted, it is preferred that neither of the amines is the hydrolysis product of the isocyanate. Rather, it is preferred that the reactants are selected from the amines and isocyanates disclosed elsewhere herein. The oil phase further comprises an active ingredient, and the amines are reacted in a ratio so that the microcapsules have a predetermined permeability with respect to the active ingredient.

The oil-in-water emulsion is preferably formed by adding the oil phase to the continuous aqueous phase to which an emulsifying agent has been added. The emulsifying agent is selected to achieve the desired oil droplet size in the emulsion. The size of the oil droplets in the emulsion determines the size of microcapsules formed by the process. The emulsifying agent is preferably a protective colloid. Polymeric dispersants are preferred as protective colloids. Polymeric dispersants provide steric stabilization to an emulsion by adsorbing to the surface of an oil drop and forming a high viscosity layer which prevents drops from coalescing. Polymeric dispersants may be surfactants and are preferred to surfactants which are not polymeric, because polymeric compounds form a “stronger” interfacial film around the oil drops. If the protective colloid is ionic, the layer formed around each oil drop will also serve to electrostatically prevent drops from coalescing. Sokalan (BASF), a maleic acid-olefin copolymer, is a preferred protective colloid.

Other protective colloids useful in this invention are gelatin, casein, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, sodium and calcium lignosulfonates, sulfonated naphthalene-formaldehyde condensates, modified starches, and modified cellulosics like hydroxyethyl or hydroxypropyl cellulose, and carboxy methyl cellulose. For the same reasons that high molecular weight dispersants are preferred, high molecular weight protective colloids (i.e., at least about 10 kg/mole, about 15 kg/mole, or even about 20 kg/mole), are also preferred.

The pH may be adjusted during preparation of the microcapsules, as with citric acid monohydrate in Example 2, to put Sokalan in the pH range where the smallest microcapsules may be prepared for the a given amount of mechanical energy input through stirring. Preferably, the pH of the emulsion is controlled between about 7.0 and about 8.0. More preferably, the pH of the emulsion is controlled between about 7.5 and about 8.0. Independent of the effect of pH on the effectiveness of the protective colloid, the pH of the mixture during emulsification is still preferably alkaline or neutral (i.e., controlled at a pH greater than about 6). The emulsification step, as well as the associated pH control, is preferably performed prior to the addition of amines.

To prepare microcapsules of a preferred diameter, the selection of a protective colloid and the conditions of the emulsification step are important. The quality of the emulsion, and hence the size of the microcapsules produced, is dependent to a great extent upon the stirring operation used to impart mechanical energy to the emulsion. Preferably, the emulsification is accomplished with a high shear disperser. Generally, the microcapsules produced by this process have a size roughly approximated by the size of the oil drops from which they are formed. Though particles much smaller than a micron would be advantageous, the economics of the preferred process prevents the formation of an emulsion in which the majority of particles have a diameter much smaller than a micron. Therefore, the emulsion is mixed to create oil drops having a median diameter preferably less than about 5 microns but typically greater than about 2 microns.

The time that the emulsion remains in a high shear mixing zone is preferably limited to only the time required to create an emulsion having sufficiently small particle size. The longer the emulsion remains in the high shear mixing zone, the greater the degree to which the polyisocyanate will hydrolyze and react in situ. A consequence of in situ reaction is the premature formation of shellwalls. Shellwalls formed in the high shear zone may be destroyed by the agitation equipment, resulting in wasted raw materials and an unacceptably high concentration of unencapsulated core material in the aqueous phase. Typically, mixing the phases with a Waring blender for 45 seconds or with an in-line rotor/stator disperser having a shear zone dwell time of much less than a second is sufficient. After mixing, the emulsion is preferably agitated sufficiently to maintain a vortex.

The time at which the amine reactants are added to the aqueous phase is an important process variable which may affect, for example, the size distribution of the resulting microcapsules and the degree to which in situ hydrolysis occurs. Contacting the oil phase with an aqueous phase which contains amines prior to emulsification initiates some polymerization at the oil/water interface. If the mixture has not been emulsified to create droplets having the preferred size distribution, a number of disfavored effects may result, including but not limited to: the polymerization reaction wastefully creates polymer which is not incorporated into shellwalls; oversized microcapsules are formed; or the subsequent emulsification process shears apart microcapsules which have formed. Where the selected auxiliary amine is an epoxy-amine adduct which is formed by the reaction of the principal amine and an epoxy reactant, the epoxy reactant may be incorporated into the oil phase prior to emulsification. Example 6 provides three examples of such a process.

The negative effects of premature amine addition may be avoided by adding a non-reactive form of the amine to the aqueous phase and converting the amine to its reactive form after emulsion. For example, the salt form of amine reactants may be added prior to emulsification and thereafter converted to a reactive form by raising the pH of the emulsion once it is prepared. This type of process is disclosed in U.S. Pat. No. 4,356,108, which is herein incorporated by reference in its entirety. The increase in pH to activate the amine salts preferably does not exceed the tolerance of the protective colloid to pH swings, else the stability of the emulsion may be compromised.

Amine reactants are therefore preferably added after the preparation of the emulsion. More preferably, the amine reactants are added as soon as is practicable after the emulsion has been prepared. Otherwise, the disfavored in situ hydrolysis reaction is facilitated for as long as the emulsion is devoid of amine reactants because the reaction of isocyanate with water proceeds unchecked by any polymerization reaction with amines. Therefore, amine addition is preferably initiated and completed as soon as practicable after the preparation of the emulsion.

There are, however, situations where it is desirable to purposefully increase the period over which amine reactants are added. For example, the stability of the emulsion may be sensitive to the rate at which the amine reactants are added. Alkaline colloids, like Sokalan, can generally handle the rapid addition of amines. But, rapid addition of amines to an emulsion formed with non-ionic colloids or PVA cause the reaction mixture to gel rather than create a dispersion. Furthermore, if relatively “fast reacting” isocyanates are used (e.g., isocyanates containing an aromatic moiety), gelling may also occur if the amines are added too quickly. Under the above circumstances, it is typically sufficient to extend the addition of the amines over the a period of between about three to about fifteen minutes. The addition is still preferably initiated as soon as is practicable after the emulsion has been prepared.

The viscosity of the external phase is primarily a function of the protective colloid present. The viscosity of the emulsion is preferably less than about 50 cps, and more preferably is less than about 25 cps or even about 10 cps. The emulsion viscosity is measured with a Brookfield viscometer with a spindle size 1 or 2 and at about 20 to about 60 rpm speed. After reaction and without additional formulation, the microcapsule dispersion which is prepared by this process preferably has a viscosity of less than about 400 cps. More preferably the dispersion viscosity is between about 100 and about 200 cps. The viscosity of microcapsule dispersions is measured according to the methods described elsewhere herein.

The discontinuous oil phase is preferably a liquid or low melting solid. Preferably, the oil phase is liquid at temperatures of less than about 80° C. More preferably the oil phase is liquid at temperatures of less than about 65° C. Still more preferably, the oil phase is liquid at temperatures of less than about 50° C. It is preferred that the oil phase is in the liquid state as it is blended into the aqueous phase. Preferably, the pesticide or other active ingredient is melted or dissolved or otherwise prepared as liquid solution prior to the addition of the isocyanate reactant. To these ends, the oil phase may be heated during its preparation.

The discontinuous oil phase may also be a liquid phase which contains solids. Whether liquid, low melting solid, or solids in a liquid, the discontinuous oil phase preferably has a viscosity such that it flows easily to facilitate transport by pumping and to facilitate the creation of the oil in water emulsion. Thus, the discontinuous oil phase preferably has a viscosity of less than about 1000 contopus (e.g., less than about 750 contopus, or even about 500 contopus). Preferably, the core material is substantially water-immiscible, a property which promotes encapsulation by interfacial polymerization.

To minimize isocyanate hydrolysis and in situ shellwall formation, a cooling step subsequent to heating the oil phase is preferred when the oil phase comprises an isocyanate comprising an aromatic moiety, because isocyanates comprising an aromatic moiety undergo the temperature-dependent hydrolysis reaction at a faster rate than non-aromatic isocyanates. It has been discovered that the hydrolysis reaction has a negative effect on the preparation of the microcapsules of the present invention. Among other problems, isocyanates hydrolyze to form amines that compete in situ with the selected amines in the polymerization reaction, and the carbon dioxide generated by the hydrolysis reaction may introduce porosity into the prepared microcapsules. Therefore, it is preferred to minimize the hydrolysis of isocyanate reactants at each step of the process of the present invention. Since the hydrolysis reaction rate is directly dependent on the temperature, it is particularly preferred that the internal phase be cooled to less than about 50° C. subsequent to mixing isocyanate and core material. It is also preferred that the internal phase be cooled to less than about 25° C. if isocyanates comprising an aromatic moiety are used.

Hydrolysis may also be minimized by avoiding the use of oil phase compositions in which water is highly soluble. Preferably water is less than about 5% by weight soluble in the oil phase at the temperature of the emulsion during the reaction step. More preferably water is less than about 1% soluble in the oil phase. Still more preferably water is less than about 0.1% soluble in the oil phase. It is preferred that the oil phase have a low miscibility in water. Low miscibility in water also promotes the formation of a useful emulsion.

The isocyanate, the principal amine, and the auxiliary amine are selected to produce microcapsules which are permeable to the core material and which have a release rate within a targeted range. Knowing the characteristic release rate of microcapsules created with a principal amine and no auxiliary amine, one skilled in the art may readily practice the invention to select an auxiliary amine to increase or decrease the release rate proportionally to the amount of the auxiliary amine used. Examples 1 and 4 demonstrate an increase in release rate realized by the substitution of the principal amine with an auxiliary amine where the auxiliary amine is a linear polyether triamine. The amines are substituted on a substantially equivalent amine basis. Example 3 demonstrates a decrease in release rate realized by the substitution of the principal amine with an auxiliary amine where the auxiliary amine is an arylalkyl diamine. The amines are substituted on a substantially equivalent amine basis.

The amines, isocyanates, and core materials identified in the discussion of the microcapsules themselves are useful in the process to prepare the microcapsules and aqueous dispersions of microcapsules. It is preferred that amines selected as principal and auxiliary amines are sufficiently mobile across an oil-water emulsion interface. Thus, it is preferred that amines selected for the wall-forming reaction have an n-octanol/water partition coefficient wherein the base-10 log of the partition coefficient is between about −4 and about 1. It is preferred that the reaction occur on the oil side of the oil-water interface, but at partition coefficient values lower than about −4 the amines are not soluble enough in the oil phase to participate sufficiently in the wall-forming reaction. Therefore, the reaction proceeds too slowly to be economical, or the disfavored in situ reaction predominates. At partition coefficient values above about 1, the amines are not sufficiently soluble in the water phase to be evenly distributed enough throughout the aqueous phase to facilitate a consistent reaction rate with all the oil particles. Accordingly, more preferably the base-10 log of the partition coefficient is between about −3 and about 0.25, or about −2 and about 0.1.

The reaction between amine and isocyanate is preferably run with an excess of amines to minimize the disfavored in situ side-reaction involving the hydrolysis of the isocyanate reactant and to maximize conversion of the isocyanate reaction. Preferably, the total amount of amines added to the emulsion is such that the ratio of the amount of added amine equivalents to the amount of amine equivalents required to complete the reaction is between about 1.05 and about 1.3, or about 1.1 and about 1.2. To further reduce the amount of isocyanate hydrolysis and in situ reaction, the reaction is preferably run at as low of a temperature as economics based on the reaction rate will allow. The reaction step is preferably performed at a temperature between about 40° C. and about 65° C. More preferably, the reaction step is performed at a temperature between about 40° C. and about 50° C.

Preferably, the reaction step is performed to convert at least about 90% of the isocyanate. More preferably, the reaction step is performed run to convert at least about 95% of the isocyanate. The conversion of isocyanate may be tracked by monitoring the reaction mixture around an isocyanate infrared absorption peak at 2270 cm⁻¹. Preferably, the reaction achieves 90% conversion of the isocyanate at a reaction time from about one-half hour to about 3 hours, or about 1 to about 2 hours, especially where the core material comprises an acetanilide.

Selection of Amine Reactants

The disclosure of the present invention allows one skilled in the art to design a shellwall composition to achieve a desired release rate of an active ingredient in a microcapsule core. For pesticidal active ingredients, the bioefficacy of microcapsules may be optimized relative to non-encapsulated forms by adjusting the release rate of the microcapsule vehicle.

A preferred method for designing microcapsule systems having predetermined release rates of active ingredients involves a plurality of reactions for preparing microcapsule dispersions. An initial microcapsule dispersion is prepared according to the reaction described elsewhere herein. The raw materials used in this first reaction form a first experimental reaction set, of which some members include the identity of the monomers involved in the shell-forming reaction, the ratio of monomers which are to be adjusted in order to affect the permeability of the microcapsule shell, and the core material composition. A standard release rate test, such as the one described in Example 1D, is performed on the microcapsule dispersion formed with raw materials described by this first reaction set, and a half-life is calculated for the microcapsules according to methods described elsewhere herein.

Another microcapsule forming reaction is performed with a different reaction set of raw materials to form microcapsules having a different calculated half-life from the microcapsules formed by the first reaction. Preferably, the ratio of monomers is varied from the ratio of the first reaction set. Also, preferably more than one additional reaction is performed likewise in order to prepare a plurality of microcapsule dispersions having different half-lives.

The progression of reactions in Examples 1 and 3 are in accordance with this method. In Examples 1 and 3, microcapsules are formed from raw materials described in a first reaction set containing monomers which include a first monomer, which is an isocyanate, and other monomers, which are a pair of amines, and a fixed core material composition. The reactions in these examples differ primarily in the ratio of the “other” monomers to each other (i.e., the amines). In this case of changing the monomer ratio for each of the reactions, half-life may be characterized as a function of monomer ratio. The functions arising from the reactions in Examples 1 and 3 are presented as FIGS. 1B and 2 respectively. Having constructed such graphs in accordance with this method, one skilled in the art may select a ratio of “other” monomers to each other to prepare a microcapsule dispersion having a desired/targeted characteristic half-life.

It is possible that the selection of a first monomer, other monomers, and core material composition are such that no “other” monomer ratio is sufficient to form a microcapsule dispersion having a targeted half-life. For example, FIG. 2 does not provide an other monomer ratio to produce a microcapsule dispersion having a half-life of greater than 30 days. In this case, the method is preferably restarted with a reaction set having a different first monomer, at least one different other monomer, and/or a different core material composition relative to the first reaction set. Changing from the reaction set given in Example 1 to that of Example 2 is an example of changing the core material composition, specifically by the addition of a diluent. Changing from the reaction set given in Example 1 to that of Example 3 is an example of changing the first monomer (i.e., the isocyanate), as well as changing both the other monomers (i.e., the amines). The selection of diluents and different monomers for new reaction sets is aided by the description of the effect of these variables on microcapsule release rate, which is found elsewhere herein.

The bioefficacy of a microcapsule dispersion may be likewise targeted by selection of microcapsule starting materials. Bioefficacy is a measure of the effect that an active ingredient has on plants, for example, the inhibition of weeds among crop plants. Through standard bioefficacy testing with microcapsules of known half-life or known other monomer ratio, as in Examples 1E and 4D, a bioeffect may be described as a function of half-life or of other monomer ratio. Thus, the method described above is also useful for the preparation of microcapsules having a release rate which is within a range of bioeffective release rates or which corresponds to a specific target bioeffect.

The method according to the present invention is also useful for selecting alternative reaction sets to prepare microcapsules having a target release rate and/or bioeffect. The method further comprises constructing a graph which is capable of displaying the relationship between microcapsule release rate and first monomer and other monomer identity and core material composition as well as other monomer ratio. Preferably, the graph is a nomograph, which shows the relationship between three variable quantities, enabling the value of one variable to be read if the other two are known. It can take the form of a series of curves on a graph of two quantities, corresponding to constant values of a third. Or, it can consist of three straight lines calibrated with the values of the variables. A fourth line is drawn between two known points on two of the straight lines: the point at which this fourth line cuts the third straight line gives the value of the unknown quantity.

Preferably, the nomograph comprises a half-life line segment, a monomer line segment, and core material composition line segment. These line segments are calibrated such that a nomograph is formed for the relationship among half-lives, combinations of other monomer ratios and first monomers, and core material compositions. Data for a nomograph is generated by performing a plurality of reactions as described above, except that any or all of the monomers, diluents and active ingredients may be changed from reaction to reaction. The selection of variables depends on which variables are desired to be represented by the nomograph.

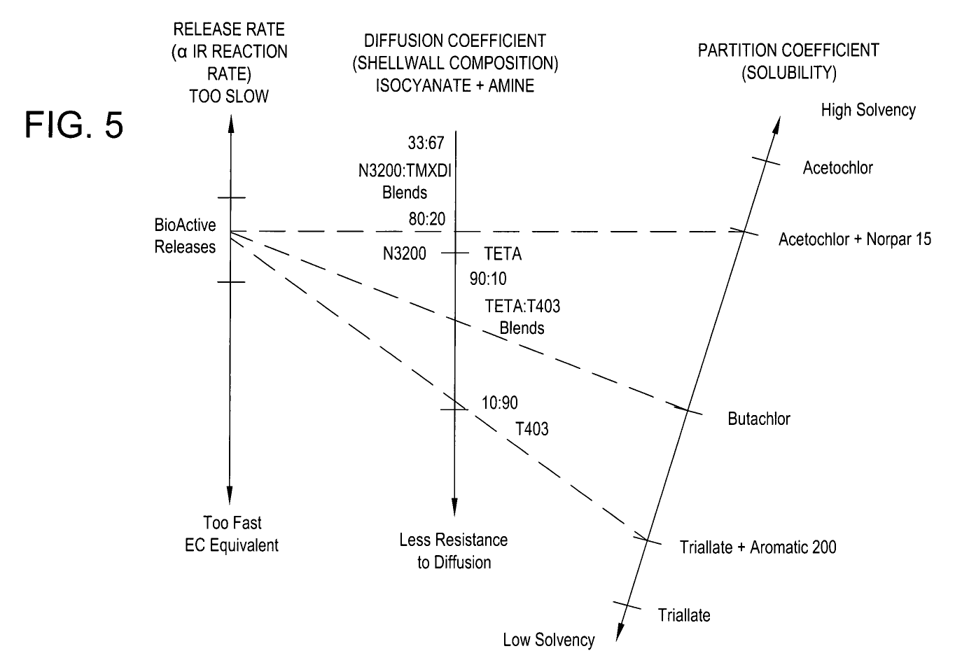

FIG. 5 is a useful nomograph for modeling and generally predicting the effect of adjusting the amine ratio in accordance with the present invention and/or an isocyanate ratio in accordance with U.S. Pat. No. 5,925,595, which is hereby incorporated by reference in its entirety. For FIG. 5, the “Release Rate” line segment is the nomograph half-life line segment; the “Diffusion Coefficient” line segment is the nomograph monomer line segment, and the “Partition Coefficient” line segment is the nomograph core composition line segment. The nomograph is constructed from data generated by a plurality of reactions to prepare microcapsules.

Various acetanilides and mixtures thereof with diluents are placed along the “Partition Coefficient” continuum in order of solubility with respect to the base polymer system. The blends of TETA (nominally the principal amine) with Jeffamine T403 (nominally the permeability-increasing auxiliary amine) are arrayed on the “Diffusion Coefficient” continuum, with increasing amine ratios extending in the downward direction. In this case, the predominant effect of changing the amine ratio is to introduce more flexible polymer segments into the shell; hence, the shellwall composition is represented as adjusting the shellwall resistence to diffusion, and the relatively negligible contribution from changing the Δδ of the system is omitted. The “Diffusion Coefficient” continuum also represents the effect on the shellwall resistence to diffusion by varying from the base case by substituting the linear N3200 with the ring-containing meta-tetramethylxylene diisocyanate. The “Release Rate” continuum represents the set possible relative release rates which may be exhibited by the various combinations of core material and shell polymer compositions. This continuum has a segment delineated “Bioactive Releases,” representing the range of release rates expected to contain the point of optimum bioefficacy in the field.

By fixing points on any two of these three continua and by extending the line thus defined to intersect the third continuum, a third point is fixed and may be used in microcapsule design. For example, fixing points at an optimum release rate for triallate and at a 10:90 TETA:T403 ratio in the shellwall indicates that using Aromatic 200 as a diluent is warranted. Or, by fixing points at an acetochlor/Norpar 15 core material and its optimum release rate, the proper shellwall composition is suggested. Or, if the bioeffect of butachlor encapsulated in a TETA:T403 shell at a 50:50 ratio is suspected to be capable of further optimization, FIG. 5 suggests how much to increase the TETA content of the shell if slower release is desired or how much to increase the T403 content if faster release is desired. More generally, a predetermined release rate for a given core material may be achieved by selecting the amine ratio suggested by FIG. 5.

The “Release Rate” continuum is subtitled “IR Reaction Rate” because the time to complete the shell-forming reaction is somewhat indicative of the characteristic release rate of the microcapsules so formed. It has been determined that polyurea-encapsulated acetanilides which react to completion (as monitored by the disappearance of the isocyanate IR peak) between about one-half hour and about three hours may be expected to have desired release rates, or at least desired release rates may be achieved by the practice of the present invention. Therefore, one skilled in the art may find useable base pairs of isocyanate and principal amine (without the need to run subsequent release rate tests) by selecting those having a time of reaction between about one-half hour and about three hours. Once a rough cut of possible base pairs has been performed, release rates may be correlated to field bioefficacy data to select a target release rate. Microcapsules having the target release rate may be prepared by varying the amine ratio and/or core diluents as described herein above.

### EXAMPLES

The following Examples are given to illustrate the invention.

### Example 1

This example demonstrates the preparation of a microencapsulated compositions of acetochlor having auxiliary amine to principal amine ratios of 60/40, 40/60, and 20/80, respectively. A polyalkene auxiliary amine, Jeffamine T-403, is selected to increase the release rate of herbicide as it is reacted in higher proportions relative to the principal amine, Jeffamine EDR 148.

### Example 1A: 60/40

External Phase Preparation:

Water (261.3 g) at 60° C. was charged to a 16 ounce jar. While stirring, Sokalan CP9 (33.2 g) (from BASF, Parsippany, N.J.) was added to the water along with casein (0.3 g). The casein dissolved in about 20 minutes. The jar was then sealed, cooled to 22° C. and held until needed. The solution was used within about 8 hours to ensure the best results.

Internal Phase Preparation:

Acetochlor (366.5 g) and MON 13900 safener (5.5 g) were charged to a 16 ounce jar and heated to 50° C. After the safener dissolved and a clear solution was achieved, the mixture was cooled to 22° C. Polyisocyanate PAPI 2027 (19.81 g) (from Dow Chemical, Midland, Mich.) was weighed into the jar. The solution was agitated to obtain a clear, homogenous solution and the sealed jar was held at 22° C. until needed. The solution was used within about 8 hours to ensure the best results.

Amine Blend Pre-Mix:

Triethylene glycol diamine, commercially available as Jeffamine EDR 148 (4.38 g) (from Huntsman Corp., Houston, Tex.), polyoxypropylenetriamine, commercially available as Jeffamine T-403 (13.01 g) (from Huntsman Corp., Houston, Tex.) and water (17.39 g) were added to a 2 ounce jar. The jar was sealed, shaken until the contents were thoroughly mixed, and held at a convenient location near the resin kettle.

Emulsification:

The external phase was added to a commercial Waring blender cup at room temperature. The Waring 700 commercial blender [Waring Products Division, Dynamics Corp. of America, New Hartford, Conn.] was powered through a 0-140 volt variable auto-transformer. The Internal phase as prepared above was added to the External phase prepared above over a 19 second interval with the speed of the blender set by the transformer at 60 volts. Within 5 seconds, the speed of the blender was increased by increasing the voltage to 110 and maintained for 15 seconds to form an emulsion. The emulsion was then transferred to a one liter, jacketed resin kettle, covered and stirred.

Cure:

Within three minutes after emulsification, the amine blend pre-mix as prepared above was added to the stirred emulsion in the jacketed resin kettle. The covered kettle was held at 25° C. for about 30 minutes. After 30 minutes, the temperature was increased over a 30 minute interval and held at 50° C. until the isocyanate infrared absorption peak at 2270 cm⁻¹ disappeared, which generally occurred within about an additional 30 minutes.

Formulation:

A 2% aqueous solution of Proxel (20.5 g) was added to the cured slurry as a preservative and Kelzan xanthan gum (0.27 g) (from Kelco, San Diego, Calif.) was added to the cured slurry as a thickener. The resulting slurry had a median particle size of 3 microns and was 44.7% active herbicide by weight.

### Example 1B: 40/60

The procedure of Example 1A was followed, but Example 1B used 6.97 g of Jeffamine EDR 148, 9.21 g of Jeffamine T-403, and 16.17 g of water to form the amine blend pre-mix. The resulting slurry was 47.5% active by weight.

### Example 1C: 20/80

The procedure of Example 1A was followed, but Example 1C used 9.90 g of Jeffamine EDR 148, 4.9 g of Jeffamine T-403, and 14.8 g of water to form the amine blend pre-mix. The resulting slurry was 47.6% active by weight.

### Example 1D: Release Rate Determination

The release rates of the microcapsules prepared in Example 1A, 1B, and 1C were determined and plotted in FIG. 1.

Procedure:

Weigh approximately 150 mg of an aqueous dispersion of microcapsules into a 100 mL volumetric flask and record weight of sample. Fill the flask to its mark with deionized water and mix. Transfer to a half-gallon jar, rinsing the volumetric flask six times into the jar. Fill the jar to a net weight of 1000 g with deionized water and 100 mL of a buffer solution made from a pH 7 or pH 4 buffer solution concentrate (Fisher Scientific). Maintain this sample at a temperature of 30° C. Sample at times of interest and record time of sampling. Filter the sample through a 0.22 micron, 25 mm syringe filter to a vial. Analyze the sample by HPLC-UV to determine the concentration of a core material compound of interest in the release medium.

Analysis:

The percent of the core material released into a large enough volume of water to be treated as a perfect sink, i.e. no back diffusion, is plotted versus the square root of time. The plot is nearly linear and its slope is the Higuchi rate constant for release. The constant is used to calculate the characteristic half-life of the microcapsules, i.e. the time required to release 50 percent of the compound of interest from the microcapsule.

Results:

The release rates of acetochlor increase and half-lives decrease as the amount of Jeffamine T-403 involved in the polymerization is increased relative to Jeffamine EDR-148.

### Example 1E: Bioefficacy Testing

Procedure:

A controlled release test was conducted with the acetochlor-containing microcapsules produced in Examples 1A, B, and C.

Barnyard grass was seeded ½ inch deep into standard 4 inch square pots which contained a Dupo silt loam soil mix. This soil mix was previously steam sterilized and prefertilized with Osmocote slow release fertilizer at a rate of 100 g/ft³. All herbicides were applied via a track sprayer in 20 gallon of liquid per acre spray volume. All herbicides were applied at a 0.5 lb/acre active ingredient rate. Black nylon window screening was placed M inch below the treated soil surface. The nylon screening enabled removal of the top ½ inch of soil surface to allow planting at subsequent bioassay dates. After planting the screen mesh was removed and discarded. The soil covers were lightly crumbled or broken up and replaced again over the newly seeded pot. To the 48 day bioassay, the 0 day bioassay pots were replanted with barnyard grass a second time. The soil cover layers from the 0 day bioassay were scraped to a depth of ½ inch, replanted and observed for herbicidal effects. Treatments were made to one soil moisture regime per normal greenhouse operations. All pots were then placed in a warm supplemental lighted (approximately 475 microeinsteins) greenhouse and alternately subirrigated and overhead “misted” as necessary to maintain adequate soil moisture for the duration of the test. Approximately two weeks after planting efficacy ratings were taken using an HP100 data collector. The data was transferred to a Macintosh computer system for subsequent processing.

Results:

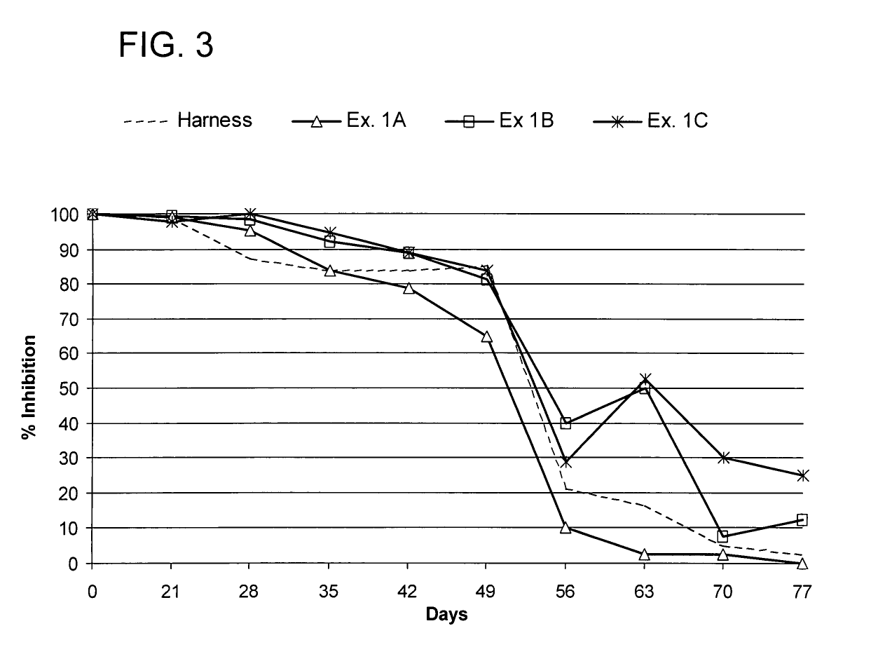

A chart tracking the percent inhibition of barnyard grass on selected days from the testing is presented as FIG. 3. The relative performance of Examples 1A, B, and C follows the measured release rates. Example 1A has the fastest release and as such the fastest drop-off in length of weed control. Example 1C shows the most extension of weed control, as would be expected from the slowest releasing formulation. Furthermore, the microcapsules produced in Examples 1B and 1C exhibit superior long-term control compared to an unencapsulated acetochlor emulsion (Harness, commercially available from Monsanto).

### Example 2

This example demonstrates decrease in release rate caused by the addition of a poor solvent for the shellwall of microcapsules otherwise produced according to Example 1B. Also demonstrated is the advantageous preferential release rate for a herbicide safener which has been formulated into the core.

External Phase Preparation:

Water (287.29 g) at 60° C. was charged to a 16 ounce jar. While stirring, Sokalan CP9 (30.6 g) (from BASF, Parsippany, N.J.) was added to the water along with casein (0.47 g). The casein dissolved in about 20 minutes. Then, citric acid monohydrate (0.45 g) was added to lower the pH of the mixture to 8. The jar was then sealed, cooled to 22° C. and held until needed. The solution was used within about 8 hours to ensure the best results.

Internal Phase Preparation:

Acetochlor (364.1 g) and MON 13900 safener (5.91 g) were charged to a 16 ounce jar and heated to 50° C. to dissolve the safener. A poor solvent for the shellwall of Example 2, Orchex 692 (30.0 g) (from Exxon Co., Houston, Tex.), was then added. After a clear solution was achieved, the mixture was cooled to 22° C. Polyisocyanate PAPI 2027 (22.61 g) (from Dow Chemical, Midland, Mich.) was weighed into the jar. The solution was agitated to obtain a clear, homogenous solution and the sealed jar was held at 22° C. until needed. The solution was used within about 8 hours to ensure the best results.

Amine Blend Pre-Mix:

Triethylene glycol diamine, commercially available as Jeffamine EDR 148 (7.49 g) (from Huntsman Corp., Houston, Tex.), polyoxypropylenetriamine, commercially available as Jeffamine T-403 (9.09 g) (from Huntsman Corp., Houston, Tex.) and water (17.39 g) were added to a 2 ounce jar. The jar was sealed, shaken until the contents were thoroughly mixed, and held at a convenient location near the resin kettle.

Emulsification:

The external phase was added to a commercial Waring blender cup at room temperature. The Waring 700 commercial blender [Waring Products Division, Dynamics Corp. of America, New Hartford, Conn.] was powered through a 0-140 volt variable auto-transformer. The Internal phase as prepared above was added to the External phase prepared above over a 19 second interval with the speed of the blender set by the transformer at 60 volts. Within 5 seconds, the speed of the blender was increased by increasing the voltage to 110 and maintained for 15 seconds to form an emulsion. The emulsion was then transferred to a one liter, jacketed resin kettle, covered and stirred.

Cure:

Within three minutes after emulsification, the amine blend pre-mix as prepared above was added to the stirred emulsion in the jacketed resin kettle. The covered kettle was held at 25° C. for about 30 minutes. After 30 minutes, the temperature was increased over a 30 minute interval and held at 50° C. until the isocyanate infrared absorption peak at 2270 cm⁻¹ disappeared, which generally occurred within about an additional 30 minutes.

Formulation:

A 2% aqueous solution of Proxel (21.72 g) was added to the cured slurry as a preservative, Kelzan xanthan gum (0.29 g) (from Kelco, San Diego, Calif.) was added to the cured slurry as a thickener and Irgasol DA liquid (28.0 g) (from Ciba-Giegy, Greensboro, N.C.) was added to the cured slurry as a dispersant. The resulting slurry had a median particle size of 3 microns.

Release Rate Determination:

The half-life was determined according to the procedure detailed in Example 1D. The addition to the core material of a relatively poor solvent for the shellwall decreased the release rate of acetochlor, raising the half-life from 33 days to 298 days. The safener release half-life was calculated to be 203 days. Thus, the safener is released at a greater proportional rate than its ratio to the pesticide in the core, increasing the benefit to young plants receiving the safener when they are emerging and are most sensitive to pesticides. This release characteristic is typical in microcapsules which release core materials via molecular diffusion.

### Example 3

This example demonstrates the preparation of nine compositions of microencapsulated alachlor, wherein a ring-containing auxiliary amine, meta-xylene diamine, is selected to decrease the release rate of herbicide as it is reacted in higher proportions relative to the principal amine, triethylenetetramine. Example 3A gives a complete description of the process of making microcapsules with an auxiliary amine to principal amine ratio of 10/90. Table 1 summarizes the results of release determination for the microcapsule dispersions prepared in Examples 3A through 3I, wherein the only significant variant in the manufacture is the relative amounts of the two amines. The half-life data of Table 1 is charted in FIG. 2.

### Example 3A

External Phase Preparation:

Water (285.5 g) at 60° C. was charged to a 16 ounce jar. While stirring, 135 technical gelatin (8.2 g) (from Milligan & Higgins, Johnstown, N.Y.) was added to the water. The gelatin dissolved in about 15 to 20 minutes. The jar was then sealed and placed in an oven at 50° C. until needed. The solution was used within about 8 hours to ensure the best results.

Internal Phase Preparation:

Alachlor (371.9 g) was preheated to 50° C. and charged to a 16-ounce jar. Then, the trifunctional biuret adduct of hexamethylene diisocyanate (30.98 g), commercially available as Desmodur N3200 (from Miles) was added to the alachlor. The solution was agitated to obtain a clear, homogenous solution and the sealed jar was held in a 50° C. oven until needed. The solution was used within about 8 hours to ensure the best results.

Amine Blend Pre-Mix:

Triethylenetetramine (“TETA”) (5.57 g) (from Fisher, Pittsburgh, Pa.), meta-xylene diamine (“MXDA”) (1.15 g) (from Mitsubishi Gas Co., Tokyo, JP) and water (6.72 g) were added to a 2 ounce jar. The jar was sealed, shaken until the contents were thoroughly mixed, and held at a convenient location until needed.

Emulsification:

The external phase was added to a commercial Waring blender cup that had been preheated to 50° C. The Waring 700 commercial blender [Waring Products Division, Dynamics Corp. of America, New Hartford, Conn.] was powered through a 0-140 volt variable auto-transformer. The Internal phase as prepared above was added to the External phase prepared above over a 16 second interval with the speed of the blender set by the transformer at 60 volts. Within 4 seconds, the speed of the blender was increased by increasing the voltage to 110 and maintained for 15 seconds to form an emulsion. The emulsion was then transferred to a one liter beaker on a hot plate and stirred.

Cure:

Within three minutes after emulsification, the amine blend pre-mix as prepared above was added to the stirred emulsion in the jacketed resin kettle. The beaker was covered and held at 50° C. for about 2 hours until the isocyanate infrared absorption peak at 2270 cm⁻¹ disappeared.

Formulation:

A 2% aqueous solution of Proxel (20.5 g) was added to the cured slurry as a preservative. At this point, the slurry was divided into two portions for analyzing the release rates of the capsules. Portion 1 comprised 346 g of slurry with no further modifications at a pH of 7.6. Portion 2 comprised 346 g of slurry that was modified with the addition of NaCl (10 g) and CaCl₂ (20 g). The salts were added to improve package stability by equalizing the density of the capsules with the external phase, and by reducing the solubility of the alachlor in the external phase. Portion 2 had a pH of 6.84. The median particle size of each portion was 4 microns.

TABLE 1

| | | | | | | | | | |
|---|---|---|---|---|---|---|---|---|---|
| Example | 3A | 3B | 3C | 3D | 3E | 3F | 3G | 3H | 3I |

External Phase

| | | | | | | | | | |
|---|---|---|---|---|---|---|---|---|---|
| Water (g) | 285.4 | 285.4 | 285.4 | 285.7 | 285.7 | 285.71 | 285.71 | 285.34 | 285.35 |
| Tech Gelatin (g) | 8.22 | 8.22 | 8.22 | 5.81 | 5.81 | 5.81 | 5.81 | 8.22 | 8.22 |
| (Product No.) | (135) | (225) | (225) | (225) | (225) | (225) | (225) | (7X) | (7X) |

Internal Phase

| | | | | | | | | | |
|---|---|---|---|---|---|---|---|---|---|
| Alachlor (g) | 371.9 | 371.9 | 371.9 | 371.9 | 371.9 | 371.9 | 371.9 | 371.88 | 371.88 |
| Desmodur N3200 (g) | 30.98 | 30.98 | 30.98 | 30.98 | 30.98 | 30.98 | 30.98 | 30.98 | 30.98 |

Amine Blend

| | | | | | | | | | |
|---|---|---|---|---|---|---|---|---|---|
| MXDA (g) | 1.15 | 2.3 | 3.45 | 5.75 | 8.06 | 9.21 | 6.91 | 0 | 12.2 |
| TETA (g) | 5.57 | 4.94 | 4.325 | 3.09 | 1.85 | 1.236 | 2.47 | 5.9 | 0 |
| Water (g) | 6.72 | 7.2 | 7.78 | 8.84 | 9.91 | 10.4 | 9.4 | 5.93 | 28.28 |

Formulation

| | | | | | | | | | |
|---|---|---|---|---|---|---|---|---|---|
| Proxel (2%) (g) | 20.5 | 20.5 | 20.5 | 20.5 | 20.5 | 20.5 | 20.5 | 20.5 | 20.5 |
| MXDA/TETA | 10/90 | 20/80 | 30/70 | 50/50 | 70/30 | 80/20 | 60/40 | 0/100 | 100/0 |
| Median dia. (microns) | 4.0 | 2.1 | 2.1 | 2.6 | 2.6 | 2.7 | 2.7 | 3 | 3.5 |
| Half-life (days) | 1.25 | 1.08 | 2.24 | 3.7 | 26.1 | 8.33 | 7.42 | 1.00 | 2.41 |

### Example 4

This example demonstrates the preparation of three compositions of microencapsulated triallate and demonstrates the improvement in bioefficacy when an auxiliary amine is reacted into the microcapsule shellwall. The three compositions represent 0/100, 90/10, and 50/50 auxiliary to principal amine ratios, wherein the auxiliary amine is Jeffamine T-403 and the principal amine is triethylenetetramine. Example 4A gives a complete description of the process of making such microcapsules. Table 2 summarizes the differences between the processes in Examples 4A, 4B, and 4C, wherein the only significant variant in the manufacture is the relative amounts of the two amines.

### Example 4A: 0/100

External Phase Preparation:

A 16 ounce jar was charged with hot water (60° C.) (299.06 g). Sokalan CP9 (19.13 g) (from BASF, Parsippany, N.J.) and Casecoat NH410 (0.32 g) (from American Casein Co., NJ) were added while stirring. The Casecoat dissolved in 5 minutes. The pH was adjusted to 7.72 with the addition of citric acid (0.29 g). The jar was then sealed, and held at 40 to 50° C. until needed. For best results the solution is to be used within 24 hours.

Internal Phase Preparation:

A 16 ounce jar was charged with triallate technical (370.0 g) and Aromatic 200 (30.0 g) (from Exxon Corp. TX), and heated to between 40 and 50° C. Then Desmodur N3200 (26.67 g) (from Bayer) was weighed into the jar. The solution was agitated to obtain a clear, homogeneous solution. The sealed jar was held between 40 and 50° C. until needed. Again, for best results, the solution is to be used within 24 hours.

Amine Blend Premix:

To a 2 ounce jar, triethylenetetramine (5.42 g) (from Union Carbide, CT) and water (5.24 g) were added and mixed thoroughly by shaking the sealed jar. No auxiliary amine was added. Examples 4B and 4C include the addition of Jeffamine T-403(polyoxypropylenetriamine from Huntsman) as an auxiliary amine.

Emulsification:

The external phase was added to a commercial Waring blender cup pre-heated to around 50° C. The commercial Waring blender (Waring Products Division, Dynamics Corporation of America, New Hartford, Conn., Blender 700) was powered through a 0-140 Volt variable autotransformer. With the speed of the blender set by the transformer at 60 volts, the internal phase was added to the external phase over a 25 second interval. Within 5 seconds the speed of the blender was increased by increasing the voltage to 110, this speed is maintained for 15 seconds. The emulsion was transferred to a two liter beaker, cover with aluminum foil and stirred.

Cure:

Within 3 minutes after emulsification, the amine blend premix was added to the stirred emulsion. The covered beaker was held at 50° C. for four hours.

Formulation:

To the cured slurry, glycerol (7.58 g) and a 4.7% aqueous solution of Proxel (9.38 g) (a preservative) were added. Then Irgasol DA Liquid (45.47 g) (a 40%s solution from Ciba Geigy, NC), Lattice NTC (3.77 g) (from FMC Cot-p., DE), and Kelzan (0.44 g) (xanthan gum from Kelco, San Diego, Calif.) were added to stabilize the dispersion. After mixing for 30 minutes, disodium phosphate (8.24 g) is added, and the mixture was stirred for an additional 30 minutes. One drop of Antifoam 5E23 (from Wacker Silicones Corp., MI) was added to finish off the preparation. The median particle size was 3.8 microns.

TABLE 2

| | Example | | |
|---|---|---|---|
| | 4A | 4B | 4C |
| Internal Phase | | | |
| Desmodur N3200 (g) | 26.67 | 18.38 | 21.32 |
| Amine Blend | | | |
| Jeffamine T-403 (g) | 0 | 13.26 | 8.55 |
| TETA (g) | 5.42 | 0.37 | 2.17 |
| Water | 5.24 | 13.62 | 10.64 |
| T-403/TETA | 0/100 | 90/10 | 50/50 |
| Reaction Time (hours) | 4.0 | 1.5 | 2.5 |
| Size (microns) | 3.8 | 4.4 | 3.9 |

### Example 4D: Greenhouse Bioefficacy Testing

Objective:

The object of this Example was to determine the efficacy of encapsulated formulations of triallate herbicide as preemergence treatments (“PRE”) versus the standard pre-plant incorporated (“PPI”) method of application of the Fargo emulsion concentrate (“EC”) triallate formulation (Monsanto Company). Due to its relatively large volatility, triallate is typically incorporated into the soil prior to planting (i.e., according to the PPI method of application), to reduce losses to the atmosphere. Encapsulation of volatile pesticides allows them to be applied without incorporation into the soil, so the application may be after planting, according to the PPE method of application, since the soil need not be disturbed.

All formulations were applied as both PRE and PPI treatments. Two rates of triallate herbicide were used for this trial, 0.25 and 0.5 lb/acre active ingredient (“ai”). Normal greenhouse moisture conditions prevailed for this trial with no special wet versus dry soil moisture regimes.

Procedures/Results:

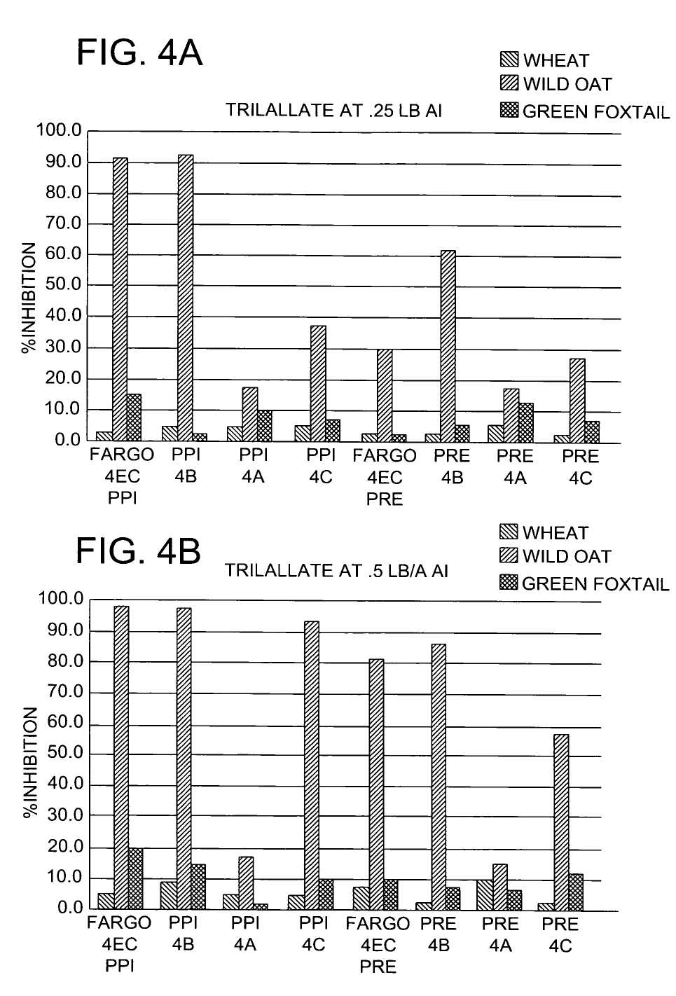

Standard PRE and PPI herbicide application was employed. FIGS. 4A and 4B are charts which report the percent inhibition of wheat, wild oat, and green foxtail for each herbicide, under both PRE and PPI conditions, at 0.25 and 0.5 lb/acre ai respectively. The product of Example 4B gave superior results compared the commercial product, Fargo EC, when applied at the same rate in pounds per acre ai. The product of Example 4C was intermediate in performance, while the product of Example 4A was clearly inferior to all. The performance was directly related to the content of the Jeffamine T-403 used to make the shellwall. The microencapsulated Example 4B of this invention provided twice the control at 0.25 lb/A rate than the unencapsulated product, and 3.5 times more control than the comparative Example 4A which did not use an amine blend of this invention. At the 0.5 lb/A application rate, Example 4B was 5.7 times more active than Example 4A.

### Example 5

Solubility Parameter

Within the limits of existing methods, the relationship between the shellwall and the core material can be quantified. The Hildebrand Solubility Parameter (δ) is normally used to characterize the solubility of a material. The definition of this parameter (i.e., Cohesive Energy/Molar Volume)^{1/2}, and the methods of measurement are well-known to anyone familiar with polymers. A material is soluble with another when their respective solubility parameters are nearly equal. Two materials are insoluble when the absolute value of the difference between their respective solubility parameters is greater than 5 (when expressed in units of J^{1/2}/cm^{3/2}). A further refinement of the concept, improving the characterization of a material, leads to dividing the parameter into three parts; a dispersive (δ_{d}), a polar (δₚ) , and a hydrogen bonding (δₙ) contribution. The relationship for swelling of a polymer (P) with a core material (C)can then be expressed by the equation:

Δδ=[(δ_{d,P}−δ_{d,C})²+(δ_{p,P}−δ_{p,C})²+(δ_{n,P}−δ_{n,C})²]

If one specifies the solubility parameter of the shellwalls of this disclosure, as a range defined by the compositional extremes, then one may characterize the solubility of the cores that can be successfully employed in this invention, using the above expression. In this example, to eliminate variations due to methodology, the solubility parameters are determined by the method of Hoftvzer and Van Krevelen (1976), as described in Properties of Polymers, by D. W. Van Krevelen, 3^{rd} Ed., Elsevier (Amsterdam, The Netherlands, 1990), Part II, Chapter 7, pp. 189-220, incorporated by reference herein in its entirety.

TABLE 3

| | | | Molar | Hildebrand Solubility | | | |
|---|---|---|---|---|---|---|---|
| | | M.W. | Volume | Parameter J^{1/2}/cm^{3/2} | | | |
| Material | Type | g/mole | cm³/mole | (δ) | (δ_{d}) | (δₚ) | (δₕ) |
| HDI¹:EDA² | Polymer | 228.33 | 191.26 | 21.96 | 17.67 | 9.17 | 9.26 |
| HDI:XDA³ | Polymer | 304.42 | 249.8 | 21.49 | 18.61 | 7.04 | 8.10 |
| diHDI⁴:EDA | Polymer | 412.57 | 335.23 | 22.68 | 17.24 | 10.82 | 10.00 |
| diHDI:TETA⁵ | Polymer | 497.72 | 414 | 22.09 | 17.00 | 9.91 | 10.02 |
| diHDI:XDA | Polymer | 489.67 | 393.61 | 22.13 | 18.27 | 8.70 | 8.96 |
| triHDI⁶:TETA | Polymer | 624.93 | 533 | 21.44 | 17.09 | 8.95 | 9.36 |
| triHDI:XDA | Polymer | 616.86 | 512.25 | 21.58 | 18.08 | 8.20 | 8.46 |
| [2-R]MDI⁷:EDA | Polymer | 309.35 | 226.52 | 23.04 | 19.56 | 8.21 | 8.99 |
| [3-R]MDI⁸:EDA | Polymer | 442.5 | 323.48 | 23.05 | 19.85 | 8.06 | 8.51 |
| [3-R]MDI: | Polymer | 531.63 | 404.15 | 22.10 | 19.40 | 6.63 | 8.25 |
| EDR148⁹ | | | | | | | |
| [3-R]MDI: | Polymer | 804.03 | 673.09 | 19.97 | 17.77 | 4.93 | 7.67 |
| T403¹⁰ | | | | | | | |
| tri HDI:T403 | Polymer | 901.31 | 809.49 | 19.37 | 16.54 | 5.83 | 8.23 |
| Alachlor | Core | 269.77 | 238.31 | 20.63 | 18.76 | 5.48 | 6.61 |
| Acetochlor | Core | 269.77 | 244.87 | 20.10 | 18.25 | 5.34 | 6.52 |
| Triallate | Core | 304.66 | 270.28 | 18.89 | 16.09 | 7.51 | 6.44 |
| Orchex 694 | Diluent | 294.56 | 349.1 | 17.53 | 17.53 | 0.00 | 0.00 |
| Aromatic 200¹¹ | Diluent | 149.21 | 149.34 | 21.26 | 21.21 | 1.48 | 0 |
| Citroflex A-4 | Diluent | 402.48 | 384.41 | 18.81 | 15.97 | 5.1 | 8.53 |

(¹hexamethylene diisocyanate; ²ethylene diamine; ³xylene diamine; ⁴difunctional biuret-containing adduct of HDI; ⁵triethylene tetramine; ⁶trifunctional biuret-containing adduct of HDI; ⁷2-ring MDI; ⁸3-ring MDI; ⁹Jeffamine EDR-148; ¹⁰Jeffamine T-403; ¹¹a C11/C12 blend).

Polymer Crystallinity

As the polymers of the present invention become more ring-like in character, especially aromatic, the release rate of microcapsules having shellwalls of such polymers generally decreases. It may be useful to visualize the polymer segments as becoming more crystalline in nature, less flexible to allow core molecules to diffuse past. The release rate decrease is generally more prominent for microcapsules comprising core materials which are relatively poor solvents for the polymer. It may be useful to visualize the effect of increasing crystallinity as only affecting the diffusion of core molecules which actually are not separated from the polymer segments by other core molecules. The greater the swelling of the polymer with core material, the less an individual core material molecule contacts the polymer (i.e., the less it “sees” the effect of the polymer segments on its diffusion through the polymer matrix).

The relative crystallinity of polymers may be expressed as a percentage to allow polymer systems to be compared to anticipate the effect that changing amine ratios will have on the shellwall crystallinity and the related effect on release rate. A measure of relative crystallinity may be calculated by dividing the molecular weight of a representative repeating segment of an isocyanate/amine polymer system into the number of aromatic units within the repeating segment. This value is then normalized against a 100% aromatic reference, benzene. For example, according to this model the relative crystallinity for a repeating segment having two aromatic groups and having a molecular weight of 312 g/mole is:

$$\frac{2 rings}{312 g \text{/} male} \times \frac{78 g \text{/} mole benzene}{1 ring benzene} \times 100 = 50 \% .$$

The crystallinity of some of the preferred polymers of the present invention are given in Table 4.

TABLE 4

| | Isocyan. | Amine | M.W. | |
|---|---|---|---|---|
| Material | Rings | Rings | (g/mole) | Crystallinity |
| HDI:EDA | 0 | 0 | 228.33 | 0% |
| HDI:XDA | 0 | 1 | 304.42 | 26% |
| diHDI:EDA | 0 | 0 | 412.57 | 0% |
| diHDI:TETA | 0 | 0 | 497.72 | 0% |
| diHDI:XDA | 0 | 1 | 489.67 | 19% |
| triHDI:TETA | 0 | 0 | 624.93 | 0% |
| triHDI:XDA | 0 | 1 | 616.86 | 13% |
| [2-R]MDI:EDA | 2 | 0 | 309.35 | 50% |
| [3-R]MDI:EDA | 3 | 0 | 442.5 | 53% |
| [3-R]MDI:EDR148 | 3 | 0 | 531.63 | 44% |
| [3-R]MDI:T403 | 3 | 0 | 804.03 | 29% |
| triHDI:T403 | 0 | 0 | 901.31 | 0% |

The data in Table 4 is useful to direct one skilled in the art to design a shellwall having a polymer composition which increases or decreases the release rate of a core material. For example, crystallinity of the shellwall may be increased (and release rate decreased) by replacing the principal amine (EDA) with an auxiliary amine having a higher crystallinity (XDA) as the amine component, and visa versa. The converse is generally true also: the crystallinity decreased (and release rate increased) by replacing a principal amine with an auxiliary amine having a lower crystallinity value and visa versa.

### Example 6

Epoxy-amine adducts may be formed during the shellwall reaction. The following three examples demonstrate the use of Araldite GY 6010 (a diglycidyl ether of bisphenol A, 190 g/eq equivalent weight, from Ciba Geigy) with TETA. The epoxy and adduct formation with this type of epoxy increases release. Epoxies derived from phenolic resins, such as EPN 1179 (also from Ciba Geigy) yield adducts with TETA that decrease release.

### Example 6A

EP Preparation

11.78 g of Sokalan CP9 and 0.3 g of casein were added to 282.3 g of water and stirred until dissolved. 0.2 of citric acid was added to adjust the pH to 7.45. The EP was preheated in a sealed jar in a 50° C. oven.

IP Preparation

22.4 g of PAPI 2027 (eq. wt. of 134 g/eq.) and 7.9 g of Araldite GY 6010 were added to 372 g of active, consisting of 92.8% acetochlor and 2.82% MON 13900 safener. The IP was preheated in a sealed jar in a 50° C. oven.

TETA Solution

6.9 g of TETA (equivalent weight of 36.56 g/eq) was mixed with 6.9 g water.

Encapsulation and Cure

The EP was added to a Waring blender cup. With the Waring running at 60 acV, the IP was added within 17 seconds (clock is started t=0 at start of IP addition). The Waring speed was increased to full speed (110 acV) for 15 seconds. The emulsion was poured into a beaker and stirred mechanically. The TETA solution was then added at t=1 minute 30 seconds. The mixture was heated for 2 hours at 50° C. At the end of the cure, 0.27 g Kelzan and 20.5 g of a 2% proxel solution were added to stabilize the microcapsule dispersion.

Reaction

0.0418 equivalents of epoxy plus 0.1887 equivalents of amine (18:82 epoxy:amine) yielded a blend of TETA and epoxy-adduct with [0.1887−(0.0418/2)=]0.1678 equivalents of amine remaining in the blend. 0.1672 equivalents of isocyanate were used to form the polyurea shellwall.

### Example 6B

Prepared as in Example 6A above, but with the following changes in the weights of the shellwall precursors: the weight of Araldite 6010 was 15.2 g; PAPI was 16.1 g; and 5.86 g of TETA was used in 5.86 g water.

Reaction

0.08 equivalents of epoxy plus 0.1603 equivalents of amine (33.3:66.7 epoxy:amine) yielded a blend of TETA and epopxy adduct with [0.1603−(0.08/2)=]0.1203 equivalents of amine remaining in the blend. 0.1201 equivalents of isocyanate were used.

### Example 6C

Prepared as in Example 6A above, but with the following changes in the weights of the shellwall precursors: the weight of Araldite 6010 was 22.0 g; PAPI was 10.3 g; and 4.9 g TETA was used in 4.9 g water.

Reaction

0.1158 equivalents of epoxy plus 0.1348 equivalents of amine (46:54 epoxy:amine) yielded a blend of TETA and epoxy adduct with [0.1348−(0.1158/2)=] 0.0769 equivalents of amine remaining in the blend. 0.0769 equivalents of isocyanate were used.

### Example 6D: Release Rate Testing

Release testing into water and analysis of a the “%released versus square root of time” plots reveal the following values for the time needed to release 50% of the active. The release half-lives are: 15.7 days for Example 6A, 9.5 days for Example 6B, and 5.8 days for Example 6C. The shellwall made from PAPI and TETA alone does not release into water, that is, its release half-life is infinity.

While the compositions and methods of this invention have been described in terms of preferred embodiments, it will be apparent to those of skill in the art that variations may be applied to the process described herein without departing from the concept, spirit and scope of the invention. All such similar substitutes and modifications apparent to those skilled in the art are deemed to be within the spirit, scope and concept of the invention.

In view of the above, it will be seen that the several objects of the invention are achieved and other advantageous results attained.

What is claimed is:

1. A pesticidal material comprising a substantially water-immiscible core material, the core material comprising a pesticide and being encapsulated in a shell having a predetermined permeability with respect to the core material, wherein the shell is formed by an interfacial polymerization of a polyisocyanate with other monomers in an encapsulation shell-forming polymerization system, said other monomers comprising a principal amine and an auxiliary amine.

2. A pesticidal material according to claim 1 wherein neither the primary amine nor the auxiliary amine is a hydrolysis product of the polyisocyanate.

3. The pesticidal material as set forth in claim 1 wherein said other monomers comprise the principal amine and the auxiliary amine in a ratio effective to provide a predetermined permeability of the shell.

4. The pesticidal material as set forth in claim 1 wherein the auxiliary amine is effective, on reaction of the polyisocyanate with said other monomers, to produce a shell of greater permeability than would be obtained by reaction of the polyisocyanate in the absence of the auxiliary amine in a reference polymerization system of composition otherwise identical to that of said shell-forming polymerization system.

5. The pesticidal material as set forth in claim 1 wherein the auxiliary amine is effective, on reaction of the polyisocyanate with said other monomers, to produce a shell of greater permeability than a shell of equal thickness as produced by reaction of the polyisocyanate with the principal amine alone.

6. The pesticidal material as set forth in claim 1 wherein the auxiliary amine is effective, on reaction of the polyisocyanate with said other monomers, to produce a shell of lesser permeability than would be obtained by reaction of the polyisocyanate in the absence of the auxiliary amine in a reference polymerization system of composition otherwise identical to that of said shell-forming polymerization system.

7. The pesticidal material as set forth in claim 1 wherein the auxiliary amine compound is effective, on reaction of the polyisocyanate with said other monomers, to produce a shell of lesser permeability than a shell of equal thickness as produced by reaction of the polyisocyanate with the principal amine alone.

8. The pesticidal material as set forth in claim 1 wherein the auxiliary amine compound is effective, on reaction of the polyisocyanate with said other monomers, to produce a microcapsule wherein the absolute value of the arithmetic difference between the respective Hildebrand solubility parameters of the core material and shell is greater than would be obtained by reaction of polyisocyanate in the absence of the auxiliary amine in a reference polymerization system of composition otherwise identical to that of said shell-forming polymerization system.

9. The pesticidal material as set forth in claim 1 wherein the auxiliary amine compound is effective, on reaction of the polyisocyanate with said other monomers, to produce a microcapsule wherein the absolute value of the arithmetic difference between the respective Hildebrand solubility parameters of the core material and shell is less than would be obtained by reaction of the polyisocyanate in the absence of the auxiliary amine in a reference polymerization system of composition otherwise identical to that of said shell-forming polymerization system.

10. The pesticidal material as set forth in claim 1 wherein the auxiliary amine reactant is selected from the group consisting of polyalkyleneamine and an epoxy-amine adduct.

11. The pesticidal material as set forth in claim 10 wherein the auxiliary amine is a polyalkyleneamine comprising a polyetheramine, the polyetheramine being prepared by reaction of an alkylene oxide with a polyalcohol and subsequent amination of terminal hydroxyl groups of a product formed by said reaction.

12. The pesticidal material as set forth in claim 11 wherein the polyetheramine has the following formula: 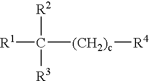
wherein:
c is a number having a value of 0 or 1;
“R¹” is selected from the group consisting of hydrogen and CH₃(CH₂)_{d}—;
“d” is a number having a value from 0 to about 5;
“R²” and “R³” are 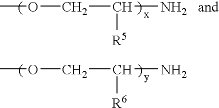
respectively;
“R⁴” is selected from the group consisting of hydrogen and 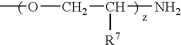
wherein “R⁵”, “R⁶”, and “R⁷” are independently selected from a group consisting of hydrogen, methyl, and ethyl; and,
“x”, “y”, and “z” are numbers whose total ranges from about to 2 to about 40.

13. The pesticidal material as set forth in claim 10 wherein the auxiliary amine is an epoxy-amine adduct comprising a product of a reaction of an amine reactant selected from the group consisting of diethylenetriamine and ethylenediamine with an epoxy reactant selected from the group consisting of ethylene oxide, propylene oxide, styrene oxide, cyclohexane oxide, and diglycidyl ether of bisphenol A.

14. The pesticidal material as set forth in either of claims 6 or 7 wherein the auxiliary amine is effective, on reaction of the polyisocyanate with said other monomers, to produce a shell of greater crystallinity than would be obtained by reaction of the polyisocyanate in the absence of the auxiliary amine in a reference polymerization system of composition otherwise identical to that of said shell-forming polymerization system.

15. The pesticidal material as set forth in claim 1 wherein the auxiliary amine comprises a moiety selected from the group consisting of an aryl moiety and a cylcloalkyl moiety.

16. The pesticidal material as set forth in claim 1 wherein the auxiliary amine is selected from the group consisting of 4,4′-diaminodicyclohexyl methane, 1,4-Cyclohexanebis(methylamine), isophorone diamine, and a compound of the following formula: 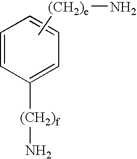
wherein “e” and “f” are integers with a values which independently range from about 1 to about 4.

17. The pesticidal material as set forth in claim 1 wherein the principal amine is selected from the group consisting of epoxy-amine adducts and a diamine of the following structure:
H₂N—X—NH₂
wherein:
“X” is selected from the group consisting of —(CH₂)ₐ— and —(C₂H₄)—Y—(C₂H₄)—;
“a” is an integer having a value from about 2 to about 6;
“Y” is selected from the group consisting of —S—S—, —(CH₂)_{b}—Z—(CH₂)_{b}—, and —Z—(CH₂)ₐ—Z—;
“b” is an integer having a value between 0 and about 4 and “a” is as defined above; and,
“Z” is selected from the group consisting of —NH—, —O—, and —S—.

18. The pesticidal material as set forth in claim 17 wherein the principal amine is selected from the group consisting of diethylenetriamine, triethylenetetramine, iminobispropylamine, bis(hexamethylene)triamine, epoxy-amine adducts, cystamine, triethylene glycol diamine, ethylene diamine, propylene diamine, butylene diamine, pentylene diamine, and hexamethylene diamine.

19. The pesticidal material as set forth in claim 1 wherein the polyisocyanate is selected from the group consisting of a linear aliphatic polyisocyanate, a ring-containing aliphatic polyisocyanate, and an isocyanate comprising an aromatic moiety.

20. The pesticidal material as set forth in claim 1 wherein the polyisocyanate is selected from the group consisting of a polyisocyanate having a methylenediphenyl moiety and a biuret-containing adduct of hexamethylene-1,6-diisocyanate of the following structure:

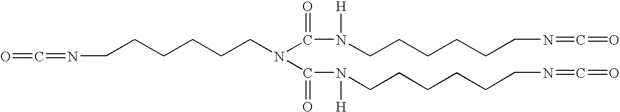

21. The pesticidal material as set forth in claim 1 wherein the shell is substantially non-porous.

22. The pesticidal material as set forth in claim 1 wherein the shell and the core material each has a Hildebrand solubility parameter, and the absolute value of the arithmetic difference between the respective Hildebrand solubility parameters of the core material and shell is less than about 5 Joule^{1/2}/cm^{3/2}.

23. The pesticidal material as set forth in claim 1 wherein the pesticide comprises an agricultural compound selected from the group consisting of a herbicide, a herbicide safener, and a fungicide.

24. The pesticidal material as set forth in claim 23 wherein the pesticide comprises an acetanilide.

25. The pesticidal material as set forth in claim 23 wherein the herbicide is selected from the group consisting of acetochlor, alachlor, and triallate.

26. The pesticidal material as set forth in claim 23 wherein the pesticide further comprises a safener.

27. The pesticidal material as set forth in claim 1 wherein the core material further comprises a diluent.

28. The pesticidal material as set forth in claim 27 wherein the core material further comprises a diluent which is selected such that the core material has a Hildebrand solubility parameter which is greater than a Hildebrand solubility parameter of an otherwise identical core material which is substantially free of the diluent.

29. The pesticidal material as set forth in claim 27 wherein the core material further comprises a diluent which is selected such that the core material has a Hildebrand solubility parameter which is less than a Hildebrand solubility parameter of an otherwise identical core material which is substantially free of the diluent.

30. The pesticidal material as set forth in claim 1 wherein the ratio of the weight of the shell to the weight of the core material is less than about 33%.

31. The pesticidal material as set forth in claim 1 wherein the microcapsule has a mass to volume ratio between about 1.1 g/cm³ and about 1.5 g/cm³.

32. An agricultural formulation comprising a dispersion of microcapsules in an aqueous phase, a microcapsule comprising a substantially water-immiscible core material, the core material comprising a pesticide and being encapsulated in a shell having a predetermined permeability with respect to the core material, wherein the shell is formed by an interfacial polymerization of a polyisocyanate with other monomers in an encapsulation shell-forming polymerization system, said other monomers comprising a principal amine and an auxiliary amine.

33. A agricultural formulation according to claim 32 wherein neither the primary amine nor the auxiliary amine is a hydrolysis product of the polyisocyanate.

34. The agricultural formulation as set forth in claim 32 wherein said other monomers comprise the principal amine and the auxiliary amine in a ratio effective to provide a predetermined permeability of the shell.

35. The agricultural formulation as set forth in claim 32 wherein the auxiliary amine is effective, on reaction of the polyisocyanate with said other monomers, to produce shells of greater permeability than would be obtained by reaction of the polyisocyanate in the absence of the auxiliary amine in a reference polymerization system of composition otherwise identical to that of said shell-forming polymerization system.

36. The agricultural formulation as set forth in claim 32 wherein the auxiliary amine compound is effective, on reaction of the polyisocyanate with said other monomers, to produce shells of greater permeability than a shell of equal thickness as produced by reaction of the polyisocyanate with the principal amine alone.

37. The agricultural formulation as set forth in claim 32 wherein the auxiliary amine is effective, on reaction of the polyisocyanate with said other monomers, to produce shells of lesser permeability than would be obtained by reaction of the polyisocyanate in the absence of the auxiliary amine in a reference polymerization system of composition otherwise identical to that of said shell-forming polymerization system.

38. The agricultural formulation as set forth in claim 32 wherein the auxiliary amine compound is effective, on reaction of the polyisocyanate with said other monomers, to produce shells of lesser permeability than a shell of equal thickness as produced by reaction of the polyisocyanate with the principal amine alone.

39. The agricultural formulation as set forth in claim 32 wherein the auxiliary amine compound is effective, on reaction of the polyisocyanate with said other monomers, to produce microcapsules wherein the absolute value of the arithmetic difference between the respective Hildebrand solubility parameters of the core material and shells is greater than would be obtained by reaction of the polyisocyanate in the absence of the auxiliary amine in a reference polymerization system of composition otherwise identical to that of said shell-forming polymerization system.

40. The agricultural formulation as set forth in claim 32 wherein the auxiliary amine compound is effective, on reaction of the polyisocyanate with said other monomers, to produce microcapsules wherein the absolute value of the arithmetic difference between the respective Hildebrand solubility parameters of the core material and shells is less than would be obtained by reaction of the polyisocyanate in the absence of the auxiliary amine in a reference polymerization system of composition otherwise identical to that of said shell-forming polymerization system.

41. The agricultural formulation as set forth in claim 32 wherein the auxiliary amine is selected from the group consisting of polyalkyleneamine and an epoxy-amine adduct.

42. The agricultural formulation as set forth in claim 41 wherein the auxiliary amine is a polyalkyleneamine comprising a polyetheramine, the polyetheramine being prepared by reaction of an alkylene oxide with a polyalcohol and subsequent amination of terminal hydroxyl groups of a product formed by said reaction.

43. The agricultural formulation as set forth in claim 42 wherein the polyetheramine has the following formula: 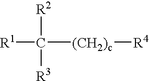
wherein:
c is a number having a value of 0 or 1;
“R¹” is selected from the group consisting of hydrogen and CH₃(CH₂)_{d}—;
“d” is a number having a value from 0 to about 5;
“R²” and “R³” are 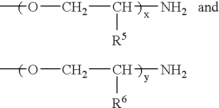
respectively;
“R⁴” is selected from the group consisting of hydrogen and 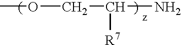
wherein “R⁵”, “R⁶”, and “R⁷” are independently selected from a group consisting of hydrogen, methyl, and ethyl; and,
“x”, “y”, and “z” are numbers whose total ranges from about to 2 to about 40.

44. The agricultural formulation as set forth in claim 41 wherein the auxiliary amine is an epoxy-amine adduct comprising a product of a reaction of an amine reactant selected from the group consisting of diethylenetriamine and ethylenediamine with an epoxy reactant selected from the group consisting of ethylene oxide, propylene oxide, styrene oxide, cyclohexane oxide, and diglycidyl ether of bisphenol A.

45. The agricultural formulation as set forth in either of claims 37 or 38 wherein the auxiliary amine is effective, on reaction of the polyisocyanate with said other monomers, to produce shells of greater crystallinity than would be obtained by reaction of the polyisocyanate in the absence of the auxiliary amine in a reference polymerization system of composition otherwise identical to that of said shell-forming polymerization system.

46. The agricultural formulation as set forth in claim 32 wherein the auxiliary amine comprises a moiety selected from the group consisting of an aryl moiety and a cylcloalkyl moiety.

47. The agricultural formulation as set forth in claim 32 wherein the auxiliary amine is selected from the group consisting of 4,4′-diaminodicyclohexyl methane, 1,4-Cyclohexanebis(methylamine), isophorone diamine, and a compound of the following formula: 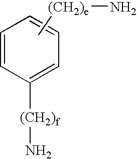
wherein “e” and “f” are integers with a values which independently range from about 1 to about 4.

48. The agricultural formulation as set forth in claim 32 wherein the principal amine is selected from the group consisting of epoxy-amine adducts and a diamine of the following structure:
H₂N—X—NH₂
wherein:
“X” is selected from the group consisting of —(CH₂)ₐ— and —(C₂H₄)—Y—(C₂H₄)—;
“a” is an integer having a value from about 2 to about 6;
“Y” is selected from the group consisting of —S—S—, —(CH₂)_{b}—Z—(CH₂)_{b}—, and —Z—(CH₂)ₐ—Z—;
“b” is an integer having a value between 0 and about 4 and “a” is as defined above; and,
“Z” is selected from the group consisting of —NH—, —O—, and —S—.

49. The agricultural formulation as set forth in claim 48 wherein the principal amine is selected from the group consisting of diethylenetriamine, triethylenetetramine, iminobispropylamine, bis(hexamethylene)triamine, epoxy-amine adducts, cystamine, triethylene glycol diamine, ethylene diamine, propylene diamine, butylene diamine, pentylene diamine, and hexamethylene diamine.

50. The agricultural formulation as set forth in claim 32 wherein the polyisocyanate is selected from the group consisting of a linear aliphatic polyisocyanate, a ring-containing aliphatic polyisocyanate, and an isocyanate comprising an aromatic moiety.

51. The agricultural formulation as set forth in claim 32 wherein the polyisocyanate is selected from the group consisting of a polyisocyanate having a methylenediphenyl moiety and a biuret-containing adduct of hexamethylene-1,6-diisocyanate of the following structure:

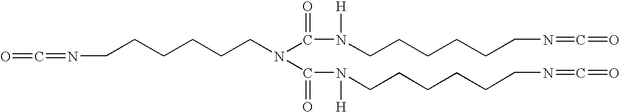

52. The agricultural formulation as set forth in claim 32 wherein the shells of the microcapsules are substantially non-porous.

53. The agricultural formulation as set forth in claim 32 wherein the shell and the core material each has a Hildebrand solubility parameter, and the absolute value of the arithmetic difference between the respective Hildebrand solubility parameters of the core material and shell is less than about 5 Joule^{1/2}/cm^{3/2}.

54. The agricultural formulation as set forth in claim 32 wherein the pesticide comprises an agricultural compound selected from the group consisting of a herbicide, a herbicide safener, and a fungicide.

55. The agricultural formulation as set forth in claim 54 wherein the pesticide comprises an acetanilide.

56. The agricultural formulation as set forth in claim 54 wherein the herbicide is selected from the group consisting of acetochlor, alachlor, and triallate.

57. The agricultural formulation as set forth in claim 54 wherein the pesticide further comprises a safener.

58. The agricultural formulation as set forth in claim 32 wherein the core material further comprises a diluent.

59. The agricultural formulation as set forth in claim 58 wherein the core material further comprises a diluent which is selected such that the core material has a Hildebrand solubility parameter which is greater than a Hildebrand solubility parameter of an otherwise identical core material which is substantially free of the diluent.

60. The agricultural formulation as set forth in claim 58 wherein the core material further comprises a diluent which is selected such that the core material has a Hildebrand solubility parameter which is less than a Hildebrand solubility parameter of an otherwise identical core material which is substantially free of the diluent.

61. The agricultural formulation as set forth in claim 32 wherein the ratio of the weight of the shell to the weight of the core material for a microcapsule is less than about 33%.

62. The agricultural formulation as set forth in claim 32 wherein a microcapsule has a mass to volume ratio between about 1.1 g/cm³ and about 1.5 g/cm³.

63. The agricultural formulation as set forth in claim 32 wherein the dispersion has a viscosity of from about 100 contopus to about 300 contopus.

64. The agricultural formulation as set forth in claim 32 wherein the microcapsules have a volume-weighted median diameter between about 2 microns and about 8 microns wherein the volume-weighted median diameter is reported by a particle size analyzer based on particle light diffraction of laser light having about a 750 mm wavelength.

65. The agricultural formulation as set forth in claim 32 wherein the microcapsules have a volumetric diameter distribution such that at least about 90% of the microcapsules on a volumetric basis have a diameter of less than about 60 microns, wherein the volumetric diameter distribution is reported by a particle size analyzer based on particle light diffraction of laser light having about a 750 mm wavelength.

66. The agricultural formulation as set forth in claim 32 comprising less than about 65 weight percent microcapsules.

67. The agricultural formulation as set forth in claim 32 further comprising an additive selected from the group consisting of a thickener, a dispersant, an antifreeze agent, a preservative, an aqueous phase density increaser, a pH buffer, an anti-packing agent, and an anti-foam agent.

68. The agricultural formulation as set forth in claim 32 wherein the microcapsules have a weight average mass to volume ratio within about 0.2 g/cm³ of the aqueous phase density.

69. A method for plant growth control comprising the step of applying an agricultural formulation as set forth in claim 32 to an agricultural field.

70. A process for the preparation of microcapsules, the process comprising the steps of:
preparing an emulsion comprising a continuous aqueous phase and a discontinuous oil phase, the continuous phase comprising an emulsifying agent and amine reactants which comprise a primary amine, and an auxiliary amine, the oil phase comprising a core material comprising a pesticide and the oil phase further comprising a polyisocyanate reactant; and
interfacially polymerizing the polyisocyanate reactant with the principal amine and the auxiliary amine to form an aqueous dispersion of microcapsules,
wherein a microcapsule comprises a shell having the core material encapsulated therein and wherein the principal and auxiliary amine reactants are reacted in an amine ratio effective to form a shell with a predetermined permeability with respect to the pesticide.

71. The process as set forth in claim 70 wherein the auxiliary amine reactant is selected from the group consisting of polyalkyleneamine and an epoxy-amine adduct.

72. The process as set forth in claim 71 wherein the auxiliary amine is a polyalkyleneamine comprising a polyetheramine, the polyetheramine being prepared by reaction of an alkylene oxide with a polyalcohol and subsequent amination of terminal hydroxyl groups of a product formed by said reaction.

73. The process as set forth in claim 71 wherein the auxiliary amine is an epoxy-amine adduct comprising an amine, the amine being prepared by the reaction of an amine reactant selected from the group consisting of diethylenetriamine and ethylenediamine with an epoxy reactant selected from the group consisting of ethylene oxide, propylene oxide, styrene oxide, cyclohexane oxide, and diglycidyl ether of bisphenol A.

74. The agricultural formulation as set forth in claim 70 wherein the auxiliary amine is effective, on reaction of the polyisocyanate with said other monomers, to produce shells of greater crystallinity than would be obtained by reaction of the polyisocyanate in the absence of the auxiliary amine in a reference polymerization system of composition otherwise identical to that of said interfacial polymerization.

75. The process as set forth in claim 70 wherein the auxiliary amine reactant comprises a moiety selected from the group consisting of an aryl moiety and a cylcloalkyl moiety.

76. The process as set forth in claim 70 wherein the polyisocyanate reactant is selected from the group consisting of a linear aliphatic polyisocyanates, a ring-containing aliphatic polyisocyanate, and an isocyanate comprising an aromatic moiety.

77. The process as set forth in claim 70 wherein the pesticide comprises an agricultural compound selected from the group consisting of a herbicide, a herbicide safener, and a fungicide.

78. The process as set forth in claim 77 wherein the pesticide comprises an acetanilide.

79. The process as set forth in claim 77 wherein the herbicide is selected from the group consisting of acetochlor, alachlor, and triallate.

80. The process as set forth in claim 77 wherein the pesticide further comprises a safener.

81. The process as set forth in claim 70 wherein the core material further comprises a diluent.

82. The process as set forth in claim 70 wherein the shell is substantially non-porous.

83. The process as set forth in claim 70 wherein the emulsion has a viscosity of from about 10 contopus to about 50 contopus.

84. The process as set forth in claim 70 wherein water is less than about 1 weight percent soluble in the oil phase.

85. A method for preparing microcapsules, wherein a microcapsule comprises a polymer shell formed by reacting a first monomer with at least two other monomers, wherein the shell encapsulates a core material which comprises an active ingredient, and wherein the shell has a predetermined permeability with respect to the active ingredient, the method comprising:
selecting a first reaction set comprising the first monomer, the other monomers, and a core material composition;
reacting the first monomer with the other monomers in an encapsulation polymer shell-forming reaction system which comprises the core material to form a dispersion of microcapsules, wherein the other monomers react in a known ratio to each other to form the microcapsule shells;
measuring a characteristic half-life of the dispersion of microcapsules, the half-life being calculated from a rate of release over time of the active ingredient from the microcapsules immersed in water;
repeating the reaction and measurement steps, for a number of iterations sufficient to characterize the relationship of half-lives of microcapsule dispersions as a function of the ratios of other monomers to each other, wherein each iteration is performed with a unique ratio of other monomers to each other; and
performing the reaction step with a ratio of other monomers to each other which correlates to a target characteristic half-life.

86. The method according to claim 85 wherein the other monomers comprise amines.

87. The method according to claim 85 wherein the first monomer is a polyisocyanate.

88. The method according to claim 87 wherein the ratio of other monomers to each other is the ratio of a first other monomer to a second other monomer.

89. The method according to claim 88 wherein the ratio of other monomers to each other is the number of functional groups reacting in the reaction step from the first other monomer divided by the number of functional groups reacting in the reaction step from the second other monomer.

90. The method according to claim 85 wherein the selected first monomer, other monomers, and core material composition are such that no other monomer ratio is sufficient to form a microcapsule dispersion having the target half-life according to the function, the method further comprising
selecting a new reaction set comprising at least one changed component which is selected from the group consisting of a different first monomer, at least one different other monomer, a different core material composition, and combinations thereof; and
repeating the reaction and measurement steps with the new reaction set for a number of iterations sufficient to describe the characteristic half-lives of microcapsule dispersions as a function of the ratios of other monomers, wherein each iteration is performed with a unique ratio of other monomers to each other prior to performing the reaction step with a ratio of other monomers to each other which correlates to a target characteristic half-life.

91. The method according to claim 90 further comprising:
applying microcapsule dispersions having known half-lives to plants;
measuring a bioeffect for each applied microcapsule dispersion;
describing the bioeffects as a function of microcapsule dispersion half-life; and
selecting a target half-life which corresponds to a desired bioeffect.

92. A method for selecting a target reaction set for the preparation of microcapsules having a predetermined release rate, wherein a microcapsule comprises a polymer shell formed by reacting a first monomer with at least two other monomers, wherein the shell encapsulates a core material which comprises an active ingredient, and wherein the shell has a permeability with respect to the active ingredient which is sufficient to provide a bioeffective release of the active ingredient, the method comprising:
selecting a reaction set comprising the first monomer, the other monomers, and a core material composition;
reacting the first monomer with the other monomers in an encapsulation polymer shell-forming reaction system which comprises the core material to form a dispersion of microcapsules, wherein the other monomers react in a known ratio to form the microcapsule shells;
measuring a characteristic half-life of the microcapsule dispersion, the half-life being a measure of release rate and being calculated from a rate of release over time of the active ingredient from the microcapsules immersed in water;
selecting new reaction sets comprising at least one changed component which is selected from the group consisting of a different first monomer, a different ratio of other monomers to each other, at least one different other monomer, a different core material composition, and combinations thereof;
repeating the reaction, application and measurement steps for the new reaction sets for a sufficient number of iterations to prepare graph comprising a half-life line segment, a monomer line segment, and core material composition line segment, the line segments being calibrated such that a nomograph is formed for the relationship among half-lives, combinations of other monomer ratios and first monomers, and core material compositions; and
selecting a target reaction set from a selection line segment on the nomograph wherein:
the selection line segment intersects the half-life line segment, the monomer line segment, and the core material composition line segment;
the selection line segment intersects the half-life line segment at a point corresponding to a target half-life;
the target reaction set comprises an other monomer ratio and a first monomer which are described at the intersection of the selection line segment and the monomer line segment; and
the target reaction set comprises a core material composition which is described at the intersection of the selection line segment and the core material line segment.

93. The method according to claim 92 further comprising:
applying each microcapsule dispersion to plants;
measuring a bioeffect for the each applied microcapsule dispersion; and
describing the bioeffects as a function of microcapsule dispersion half-life such that the target half-life is selected which corresponds to a desired bioeffect.
